(19) United States
(12) Patent Application Publication
(10) Pub. No.: US 2002/0154787 A1
(43) Pub. Date: Oct. 24, 2002

(54) Acoustical to optical converter for providing pleasing visual displays

(76) Inventors: Richard F. Rice, Huntsville, AL (US); Gary Smith, Huntsville, AL (US); Paul Smith, Huntsville, AL (US)

Correspondence Address: NIXON & VANDERHYE P.C., 8th Floor, 1100 North Glebe Road, Arlington, VA, 22201, US

(21) Appl. No.: 10/013,849

(22) Filed: Dec. 13, 2001

Related U.S. Application Data
(60) Provisional application No. 60/269,382, filed on Feb. 20, 2001.

(51) Int. Cl. H04R 29/00; H04B 1/00

(52) U.S. Cl. 381/124; 381/61

(57) ABSTRACT

A modular light dancer controller for use with holiday and other lighting displays is used to create dynamic, interesting multi-colored lighting displays in response to sound. The system includes dynamic release characteristics, “no music” detection, zero crossing detection, an output daisy-chaining capability, and a variety of other advantageous features which provide many benefits.

### CROSS-REFERENCES TO RELATED APPLICATIONS

This application claims the benefit of U.S. Provisional application serial No. 60/269,382 filed Feb. 20, 2001 entitled “Acoustical to Optical Real Time Converter” (attorney docket 3937-2), the entire content of which is hereby incorporated by reference in this application.

### STATEMENT REGARDING FEDERALLY SPONSORED RESEARCH OR DEVELOPMENT

Not applicable.

### FIELD OF THE INVENTION

The present invention relates to providing visual indications, and more particularly, to sound-responsive illuminated displays. Still more particularly, the invention relates to acoustical to optical real time converters; to multi channeled AC line control to provide multi-colored dancing lights responsive to audio inputs; and to audio controlled light dancers for Christmas and other light displays.

### BACKGROUND AND SUMMARY OF THE INVENTION

Around the holidays, many peoples' thoughts turn to elaborate holiday lighting. The day after Thanksgiving has become the unofficial “decorate your house for the holidays” day in many parts of the United States, with folks having fun decorating their houses with all sorts of elaborate, amazing and colorful holiday lights. This light display phenomena is no longer confined to Christmas and Hanukah—many folks use light displays to decorate their homes for other holidays too (Halloween for example).

Effective holiday lighting displays have also taken on an important role in commercial and other contexts. For example, the White House's elaborate holiday light display has become an important American tradition. The huge lighted Christmas tree in Rockefeller Center in midtown Manhattan has always attracted large numbers of New York City visitors and shoppers. Many large department stores and shopping malls set up elaborate holiday light displays. Many corporate, governmental, civic and religious organizations also set up very elaborate and impressive lighting displays to celebrate the holidays. Amusement and theme parks, county fairs, and other major public events use such elaborate lighting displays throughout the year to attract, excite and dazzle attendees.

In the lighting display industry, innovative lighting display effects that capture the interest and imagination of consumers can be extraordinarily successful. While some light display consumers may be content to put up the same lighting display year in and year out, many consumers want new and interesting lighting display effects. For example, consumers were eager to snap up the “icicle effect” light strings that came onto the market a few years ago. Now, a significant percentage of consumers decorate their homes using such “icicle” light strings.

In the 1970's, a skilled and innovative engineer named Grover Smith of Huntsville Alabama came up with an innovative design for a Christmas tree light controller that controlled Christmas tree lights to dance in response to music from a high fidelity sound system. Grover Smith's experimental prototype provided very interesting lighting effects by controlling five different-colored Christmas tree light strings to “dance” in response to audio.

The electronics of Grover Smith's experimental prototype was based on a so-called “color organ” printed circuit board from a kit. This printed circuit board provided five separate output channels to control five separate electric lamps (Grover used them to control five separate light strings). Many types of fairly elaborate and interesting lighting display system “color organs,” or mechanisms which modulate colored lights to sound or music for pleasing effect have existed in the sphere of electronic experimentation for more than 30 years. Early examples include the “Sonalite” (ref: Popular Electronics, “The ‘“Sonalite’” May 1968), the “Psychedelia 1” (ref: Popular Electronics, “Psychedelia 1” September 1969), and other light controllers (ref: Popular Electronics, “Christmas Tree Lights Keep Time to Music” December 1969). It appears that Grover Smith may have used one such kit design as the basis for his holiday light dancer experimental prototype.

Grover Smith's experimental prototype was housed in a clam shell box that had five electrical output sockets on the back. These sockets required special 2-pin connectors—and therefore, conventional Christmas light strings could not be plugged into the experimental prototype without modification.

Grover Smith's experimental device had fifteen separate adjustment knobs to provide a wide range of adjustability. Each output channel had three adjustment knobs to control various parameters of the light dancing effect. For a given channel, one knob provided a trigger point for the lighting effects; a second knob adjusted amplitude sensitivity; and a third knob adjusted the channel's frequency center.

Grover Smith's experimental prototype required a higher level of audio input than typical line audio levels. To solve this problem, Grover Smith used an external vacuum tube preamplifier that amplified both the left and right channels of the stereo output based on inputs supplied through RCA jacks. He built this vacuum tube preamplifier by modifying an old vacuum tube table radio.

Grover Smith's experimental prototype was very innovative and provided his family and friends with a very interesting light dancing display around the holidays. However, further improvements are possible and desirable. For example, Grover Smith's design was never productized, and his experimental prototype could never have been sold as a product nor was it ever intended to be.

One area of improvement includes cost-effectiveness—which is an important factor in lighting display equipment and supplies. While big corporations such as huge shopping malls are able to spend significant dollars to invest in lighting display equipment that can be used over and over again, the average consumer tends to be cost-conscious when it comes to holiday lighting displays. Pacific rim manufacturers have become extraordinarily skilled in manufacturing a variety of lighting display equipment at relatively low cost. Consumers have therefore become accustomed to buying quality, safe holiday lighting display equipment at relatively low cost. This implies that successful holiday lighting equipment for home use will tend to be relatively inexpensive—although more elaborate and robust lighting display systems for commercial and other non-residential applications can cost more and still be widely accepted and successful.

Another area for improvement relates to reliability and ease of use. Grover Smith's experimental prototype provided fifteen different adjustments—which is quite suitable for an engineer or hobbyist but is generally not desirable or practical in a mass-marketed consumer product. In particular, most consumers might generally rather have a minimal number of adjustments in order to get a pleasing light display. An increased number of manual adjustments may undesirably increase the cost of the module while providing little advantage to the average consumer who wants to quickly hook up the device and get it working without having to worry about making a number of different adjustments.

Eliminating such adjustments presents a challenge in terms of developing a “one size fits all” audio processing and filtering arrangement that can provide an effective and pleasing light display for various different kinds of music ranging from classical to rock to Christmas carols, and which will reliably adapt to a variety of different audio input sources ranging for example from high end stereos to portable Discman CD players to live sound microphonic pickups.

Yet another challenge relates to making it convenient to connect such a device in an average or commercial environment. In a home environment, for example, a stereo may be located far away from the Christmas tree or other lighting display. Christmas tree light strings may have relatively short cable lengths. The average consumer probably will not want to run a large number of extension cords across the room from the Christmas tree to the stereo. Since the desired objective of an interesting light display is generally aesthetic, the ability to conceal the wiring and other interconnections is going to be important to most consumers.

Another possible area for improvement relates to maintaining a high level of interest in the light display. Many of the color organs from the 1970's were initially interesting to look at but became superfluous once the novelty wore off. It would be highly desirable to develop a multi-colored light display that correlates with musical content in a way that will maintain a viewer/listener's interest over time. Lights that simply flash in time to the music may not be sufficient to maintain this higher level of interest. If additional kinesthetic, psychological or other features could be designed into the light display in a cost-effective and reliable manner, the resulting display might be able to maintain a high level of interest and fascination over the course of many hours.

Another possible area of improvement relates to what happens to the display when the musical content stops. If a Christmas tree is driven by a sound source based on a recording for example, what happens to the Christmas tree when the recording ends? It is generally desirable that the light display is closely correlated to the sound. This means that loud sounds will generally create bright illumination, quiet sounds will create dimmer illumination, and no sounds will create no illumination. It is perfectly appropriate, therefore, that very quiet passages in music (e.g., the time between successive movements or songs) will control the Christmas tree to provide zero illumination. On the other hand, once the recording ends, it might be desirable for the lighting display to take some different action (i.e., provide some sort of illumination in the absence of music).

A commercial environment such as a shopping mall may present additional issues. For example, it is common for a shopping mall to have only a single overall sound system used for background music and as a public address system for making announcements. Similar issues arise in amusement parks and other outdoor lighting displays. It may be desirable in such contexts for the lighting display to react in a certain predetermined way to the public address announcements. Also in such contexts, the public address/sound system may be located a substantial distance away from the lighting display. It may be undesirable to run a number of electrical extension cords between the public address system and the lighting display.

Illustrative exemplary but non-limiting embodiments disclosed herein address these issues by providing a new and improved audio-to-optical real time converter that provides a pleasing and effective lighting display that is pleasant and interesting (and can be almost mesmerizing) in its effect, and yet can be provided using reliable, cost-effective, convenient and simple-to-operate equipment. It is designed in one exemplary illustrative embodiment to be quickly and easily connected to unmodified sound source devices.

In accordance with one non-limiting aspect of an illustrative embodiment, robust analog audio filtering circuitry having wide dynamic range and dynamical decay and sustain characteristics is used to trigger lighting control switching arrangements. The signal processing may be performed using low-cost analog circuitry and/or digital signal processing such as for example a low cost digital signal processor. The resulting illustrative system is capable of responding to widely varying audio input levels, and provides a pleasing visual effect incorporating enhanced “soul” or other intangible responsivity characteristics. The dynamic decay/sustain characteristics used in one embodiment rely on advanced digital signal processing techniques to provide a fast attack and a dynamically slow decay that is inversely related to the decay of the sound signal input.

In accordance with yet another illustrative and non-limiting aspect, a combination of analog and digital circuitry is used in a hybrid manner to provide cost-effective, reliable audio signal processing.

In accordance with another non-limiting aspect, convenience is obtained by providing a modular design including two different modules:

an audio processing module (“optical rhythm module” or “ORC”), and

an AC switching module (“distributed lighting module” or “DLM”).

The two modules may be linked together via a convenient linking signal path such as, for example, a thin multi conductor cable, a wireless interface, or any other convenient communications means. By allowing the switching module to be located remotely from the audio processing module, the switching module can be placed at a convenient point where the lighting power inputs can be accessed (e.g., at the base of a Christmas tree) and the audio processing module can similarly be located at a convenient place relative to where audio outputs are available (e.g., at the back of a stereo system, home entertainment system, etc.).

The convenient interconnection between the two modules can be provided so that it does not aesthetically detract from the lighting display environment. Furthermore, a convenient interlinking connection if in cable form can be hidden (e.g., placed beneath carpeting or otherwise concealed) and run substantial distances (e.g., in the case of the sound system being located at a distance from the lighting display).

In accordance with another non-limiting illustrative aspect, particularly optimal audio filtering is used to provide esthetically pleasing light dancing and other effects for a wide range of different types of musical content ranging from Christmas carols to classical music to rock and roll. These particular audio filtering characteristics were developed empirically based on many hours of testing, and avoid the need for constant and troublesome adjustment of the audio processing characteristics for each song or different type of musical content.

In accordance with yet another illustrative and non-limiting aspect, different power switching modules can be used depending upon the particular application. For example, in a home environment, a lower cost, lower-current power switching module can be used to conveniently switch different Christmas or other light strings on and off. In a higher demand commercial environment, a more robust, higher-current power switching module having the form factor of an AC power strip for example may be used to switch higher illumination levels and more extensive lighting displays.

In accordance with yet another illustrative and non-limiting aspect, the switching modules can be “daisy chained” and distributed along a substantial distance. This allows a single audio processing module to control a huge, distributed lighting display.

In accordance with yet another illustrative and non-limiting aspect, the audio processing module incorporates an AC-signal phase sensing capability.

In accordance with still another illustrative and non-limiting aspect, the audio processing module detects when there is no incoming audio source material (e.g., when changing CD's), and operates in a “no music” mode to make the lighting display behave in a manner that is suitable for the situation. In certain prior art color organ designs, the absence of music caused the light display to be dark. This dark mode was perfectly appropriate in those contexts, but it may be undesirable in the context of a holiday light display. For example, when using a Christmas tree as a lighting display, the tree would become dark after the record or compact disk ended—and someone would have to take an additional action (e.g., play another recording, disconnect or turn of the control system, etc.) to bring the tree back to life. In accordance with an innovative non-limiting aspect of our design, we have “no music” mode that causes the display to light up in some way in the absence of music. For example, a Christmas tree could become fully lit when the system detects the absence of music for more than a predetermined time period. Other modes are also possible, for example:

fully illuminate a special part of the light display such as for example all white lights;

go into an automatic “light dancing” sequencing mode based on timing effects where illumination of different colored lights are ramped up and down or flashed in sequence or in synchronism;

illuminating each of multiple lights in a display in a predetermined pattern;

sequence between different light behaviors (e.g., by selecting between different illumination (e.g., “no music”) modes in a random order and/or in a predetermined sequence);

“replaying” previously displayed light sequences based on recently displayed audio-responsive lighting displayed (allowing the viewer to correlate the display with the music or audio he or she heard just previously);

randomly jumping between light strings in a quick tempo from dim to bright to dim, with the next color displaying being a surprise;

providing a “walking” light display in which plural differently colored light strings light up simultaneously in different combinations that are selected in a predetermined sequence and/or are randomly selected, to provide an illusion of a lighting progression;.

a lighting display that takes into account the geometry and/or placement of different colored lights, e.g., to provide a bright/dim walking light display that appears to “spread” and “contract” by ramping in and out of the display, to provide an illusion of motion;

selecting an alternate background light display (e.g., a white or other colored background lighting display such as skirt lighting, standard blinking or flashing Christmas tree lights, which could be located at the same or different positions as the audio-responsive lighting display);

selectively activating an alternate power switching module;

activating a non-illuminating or other type lighting display;

controlling external devices to mute or deactivate;

providing any other sort of visual display (e.g., activating another device altogether).

In accordance with yet another non-limiting aspect, the “no music” mode can be detected by polling plural band-limited channels and detecting whether no minimal sustained (non-transient) relative audio level is present on at least one (or more than one) channel. For example, in one exemplary embodiment, if essentially the same amplitude is present on all channels for a predetermined time, then the system can begin operating in the “no music” mode. If the “no music” mode is detected too early in one exemplary non-limiting embodiment, then the system might mistakenly begin operating in a “no music” mode during quiet passages or pauses in content—which may be disconcerting to the viewer. Similarly, in one exemplary non-limiting embodiment, it may not be desirable to operate in a “no music” mode during the spacing between songs on a compact disk or recording. Similarly, if the system is already operating in a “no music” mode in one exemplary embodiment, it should not begin operating in the “music mode” in response to short-term sounds (e.g., voice pages, etc.) since this might take away from the surprise factor of seeing the lights dancing to music once the music begins.

In accordance with an additional non-limiting aspect, the “no music” mode can be programmable in one exemplary embodiment.

In accordance with yet another aspect, the “no music” mode could be triggered in a variety ways (e.g., loss of peak amplitude for a predetermined time period, detecting abrupt change in content such as commercial or other voice announcements, etc.).

In accordance with another non-limiting aspect, the system can operate in a Karaoke mode in which the light display follows the voice of a Karaoke singer. The system in this arrangement can thus mix music with voice coming in on two separate channels.

The following is a non-limiting, illustrative listing of additional advantageous features and benefits provided by preferred exemplary embodiments:

Example Overall System:

An optical rhythm controller audio processing module and one (or more) distributed light module(s)

Any combination of an optical rhythm controller and up to any number (e.g., 6) distributed light modules whose design supports signal distribution at a long distance (e.g., up to 600′ in one embodiment) of aggregate distance from the optical rhythm controller to the furthest distributed light module. This provides for installation of distributed light module(s) at any points along the signal distribution cable.

A test tool to aid in the installation that:

1) Cycles through each frequency for a predetermined time (e.g., 10 seconds) to test distributed light module connectivity.

2) If another optical rhythm controller with different software is chosen, these tests could become very elaborate.

The system accounts for a number (e.g., four) distinct frequency color channels. A further channel can be reserved for audio detection and light effects in the absence of music (this fifth channel may be virtual, or it may be an actual wideband signal processing channel).

Meets all UL/CSA test requirements.

Meets all required FCC test requirements.

Meets all safety test requirements.

Possibility of wireless (e.g., RF) audio provided external to the optical rhythm controller using off the shelf components:

1) Distance of 400′-600′ within line of sight

2) Use license free frequency

3) 10 kHz analog bandwidth (monaural ok)

4) 30 dB signal plus noise to noise (S+N/N)

5) Secure

6) Isotropic, 50 mW (unidirectional, OdBi) rubber duck antenna

Example optical rhythm controller:

Accepts line level audio input

Maintains stereo separation with the line level input

Detects when no audio is present and communicates that to the processor

Performs the “soul” characteristic (fast attack, slow decay)

Input audio via a pair of RCA connectors

In the case when monaural audio drives the optical rhythm controller, a “Y” or other splitter cable or connection can be used externally or internally to provide a higher overall signal level (e.g., to better center the input level within the dynamic range of the system).

Example optical rhythm controller power adapter:

A low voltage AC transformer

120V/60 Hz input

Have existing certifications UL/CSA-with detailed data sheets for testing

Example optical rhythm controller external interfaces:

A coax or other jack for audio input transformer

Two RCA phono audio connectors, left and right

A LED or other display to indicate the module is powered

Two RJ12 jacks or other convenient linking connection (e.g., 6 wire)

1) One common

2) One wire for each of the channels (e.g., 0-5V<=15 mA)

One selector switch (e.g., 4 pole, 4 throw) to communicate modes to determine the performance of the lights in the absence of music.

An optional single front panel, linear taper, potentiometer with tamper proof, vibration resistant bushing (locking nut) can be used to set the optical rhythm controller input line level system gain if desired.

Example Software:

Low cost processor operating at a minimum clock frequency in order to minimize unintended electromagnetic emanations

Can poll any convenient number of channels

Upon input of signal from channel 1-4 DC levels, {0.0V-0.040V dead band; (1.041V-5.0V) active band}, monitor each channel and perform linear voltage to pulse width conversion (e.g., with current squared power normalization).

Output to the distributed light module over the RJ12 or other connector,

light intensity based on the input of a corresponding filtering channel

Read the selector switch or otherwise determine what action to take in the absence of music.

Determine the absence of music by polling the channels.

If no music is detected for a predetermined time (e.g., 10 or more seconds):

3) And the selector switch is in the first position, channel 5 lights full on only (Default)

4) And the selector switch is in the second position, all colored lights (channels 1-4) and channel 5 lights full on

5) And the selector switch is in the third position, all colored lights (channels 1-4) full on (Channel 5 off)

6) And the selector switch is in the fourth position, all 5 channels sequence beginning with channel 1 (start dim, brighten gradually over X seconds then dim gradually over Y seconds)

7) Other possibilities (e.g., all lights off or muted).

Example optical rhythm controller packaging

plastic housing

potted to protect design

compact

Have a slot for mounting band or mounting tie

Example distributed light module

Contains five 3-prong grounded sockets each representing a different channel (frequency-light combination)

Powered by a 3-prong grounded plug to commercial power

Accepts signal for each of plural channels via one or more pairs of (e.g., a RJ12) connectors

Adjusts power to each light plug in accordance with power provided to/for that channel

Be UL/CSA Listed, conforming to applicable safety standards and other compliance regulations

Passes FCC Part 15 B

Has an appropriate (e.g., 15 amp) circuit breaker or fuse

Is capable of daisy chaining multiple distributed light modules via an “analog unidirectional local area network” (AULAN) or other communications network or technique

Plural (e.g., up to 6) distributed light modules can be linked for a lengthy total distance in a single analog unidirectional local area network

Example distributed light module external interfaces:

One power plug,, 2-prong, 3-prong grounded 6′ or other cord

Plural light sockets, 2-prong, 3-prong grounded or other

RJ12 or other input and/or output control signal connectors

Example distributed light module packaging

Provides sufficient heat sinking (e.g., for 1800 Watts) for the triacs or other power switching devices

Has same form factor as a conventional power strip in one embodiment

Minimizes touch labor

Not be potted in one exemplary embodiment

RJ12s to be at opposite ends of the module to facilitate daisy chaining

ADT (Automatic Dynamic (Threshold) Tracking) via Firmware controlled optical pulse width modulator is unique.

Useful with audio frequency “Line Levels”/Higher Level “Speaker Output” sources.

Dynamic (Audio input to Optical light output) range is outstanding; Tracking ≧40 dB, typically 51 dB (e.g., 0.14 peak-to-peak to 5.0V peak-to-peak)

When music source begins the device does not immediately begin controlling the lights; the exemplary optical rhythm controller is designed to evaluate the input signal for a predetermined time (e.g., approximately 1.5 seconds) to insure that there is really music and not unintentional momentary hum, noise, or short duration nuisance transients.

“Soul”; fast attack—slow decay behavior of the optical rhythm controller. This behavior is global. Independent of the system's dynamic frequency vs. intensity (loudness) vs. time tracking, each channel independently enjoys its own attack/decay start point that has been real time calculated for that channel. The aggregate music optical effect with each channel behaving independently with respect to frequency, and intensity coupled with per channel optimized “attack/decay” times results in a very unique—pleasurable experience by the user.

The “soul” has two components: attack and decay.

The attack time is semi-instantaneous. It is as real time as possible (e.g., with (1/120) sec. maximum latency) and can be designed into the hardware.

The decay has two determining drivers in the exemplary embodiment; hardware and firmware. Exemplary hardware provides a specifically determined function of the intentionally non-limited post-detected RC time constant prior to the microcontroller based pulse width modulator. Consider this as a fixed decay bias. The software provides a dynamic firmware addition to each channels independent fixed hardware “RC” decay. The augmented decay time is the sum of both; static hardware bias and dynamic instantaneous calculated firmware additive in the exemplary illustrative embodiment. The firmware dynamic component is channel independent, and is derived via the microcontroller's real time evaluation of the particular frequency channel's amplitude at any given time. Therefore the aggregate audio to optical correlation is multiply dynamic.

Although any frequency channel can be assigned to any light string color (by simply plugging into a different DLM socket), an optimal color vs. (frequency) channel utilized that is based on hundreds of hours of critical listening and subjective appreciation evaluation (namely frequency band vs. color):

Low frequency channel (1): Red

Low-mid frequency channel (2): yellow

Mid frequency channel (3): Green

High Frequency channel (4): Blue

Auxiliary channel (5): White

There are four frequency channels that are included in the exemplary optical rhythm controller. A fifth output (only) channel also exists. Any quantity of frequency channels and likewise corresponding colored lights could be implemented in the invention. Four channel operation was selected for current product price point control and due to the limited availability of inexpensive Christmas tree light colors.

The optical rhythm controller controls incandescent lamps. Any mix; miniature light strings of 50 bulbs (120 VAC-200 MA/String), simple large or small bulbs or collections are valid for use.

Uses are unlimited; personal home, commercial or industrial—limited only by one's imagination. Example: seasonal, different holidays, dorm/frat house parties, background dynamic lighting, theatrical, band/entertainers' use, appreciation of music/dancing by hearing impaired, etc., etc.

Electrical audio inputs are magnetically isolated via internal interstage impedance matching coupling transformers.

Input loading of source is hardware determined; typically <1% of that power supplied by external source/sources is required for proper optical rhythm controller operation.

Input is full differential; therefore safe since optical rhythm controller failure will not affect driving source/sources and vice-versa.

Multiple simultaneous inputs are possible.

Multiple inputs are dynamically summed before optical correlation/conversion occurs.

Two channels are implemented in the current optical rhythm controller.

Multiple channels permit operational advantages and benefits. For example, without a need or requirement for input source cable swapping and reconfiguring, two (or more) audio sources can control lights—given that i.e. mixing board limits optical rhythm controller active input to one and only one source at any given time. This permits a “mall” performance (say at the Santa booth to continue during a lost child page). In this scenario the lights will behave based on the instantaneous sum of the two aforesaid audio sources.

Light intensities correspond to summed/aggregate instantaneous inputs.

Implemented two input channels in current optical rhythm controller; allows stereo (L&R) or independent monaural inputs. Optical rhythm controller provides e.g. ≧28 dB channel separation. Therefore, use of the optical rhythm controller doesn't cause unintentional stereo to monaural contamination to back feed to the audio source and therefore loudspeakers. Stereo separation and auditory enjoyment is maintained while optical rhythm controller is functioning.

Input transformers have current limit resistors within balanced design. Use of 1/16 watt resistor power rating implies max power limit. If power level is exceeded, in the worst case, an input could fail—resulting in an OPEN circuit. Therefore, optical rhythm controller is safe and inherently protects source from inappropriate loading following severe stressing and damaged module won't affect connected source; optical rhythm controller simply won't function in one exemplary embodiment.

optical rhythm controller functions “with” AND “without” active source input. Without (music) input optical rhythm controller enters (herein defined) “NO music mode” (<40 mVpp for previously stated period).

“No music”; an infinite number of input absent active light output behaviors are possible. Four are implemented.

Output channel 5 in the current optical rhythm controller is an additional output light channel. This is used under “no music” mode control only. Numerous additional output channels are possible and could be included (defined for use) in some or all of user selected/defined (possible) “no music” modes.

Current optical rhythm controller allows one of its “no music” modes to include overlapping light channels with “off-dim to bright to dim-off” behavior. The colors, in geometric order, can walk. Very appealing display (i.e. large strip of colored lights hanging from ceiling service ramps in malls;

Disney World, Rockefeller Center Tree, Pink Floyd, etc.) Tens of thousands of lights are possible for illumination and control by the optical rhythm controller.

No practical limit to quantity of user mode “no music” definitions.

No limit to quantity of lights.

One example implementation could allow audio source mixed with strategically planned live microphone for real time user feedback (i.e. kids at mall sitting on Santa's lap talking, visitors at home party talking near Christmas tree, restaurants, bars, clubs, Karaoke performances, etc.) Lights will track voices on top of current music being optically displayed.

optical Karoke mode

Light Dancer system is modular.

Light Dancer doesn't have to be modular; home module can be all in one.

Modular permits separation of low power (optical rhythm controller) from high power/higher heat (DLM) output units.

Connection clutter is minimum with modular design.

Input level control allows system dynamic range to slide based on input source type (high power or low power). Upper and lower Voltage peak to peak levels shift with adjustment; automatic dynamic range remain preserved.

Automatic dynamic tracking.

Optical rhythm controller connects to DLM's using low voltage, inexpensive 6 conductor #26 telephone cable & RJ 12 connectors.

Optical rhythm controller is short circuit protected. optical rhythm controller won't break if output cable is shorted; simply won't work. Correct module behavior is restored when fault is removed.

An infinite number of DLM's in optical rhythm controller fan out is possible; 5 is limit in current system design.

Optical rhythm controller is compatible with a number of different DLM designs.

Three “phase power adaptation” module (PPA) available.

Independent of phase delay selected (0, 120, 240 degree), the phase power adaptation behaves as a DLM expander. Example: DLM channels 5-8 are via PPA #1; DLM channels 9-12 are via PPA #2, and so on. (e.g., this example refers to a PPA using a fifth channel fanout in each case).

Light dancer enjoyed by any age, any culture; including hearing impaired.

Additional attack/decay time constants are easily achievable/tailorable for different culture's music. Example: East Indian (string music) may need to have less decay to avoid transient current music note (fast) from being time smeared with previous musical note.

Future optical rhythm controller could be implemented in custom LSI (Large Scale Integrated circuit).

User memory cartridges could be made for input to optical rhythm controller processor. Customer can select between myriads of “music” and “no music” modes.

User can download new choices from PC or Mac via provided software.

User can invent new “music” and “no music” modes on a personal computer; download or direct control optical rhythm controller.

A random “no music mode” selection could be implemented.

Random music mode behavior could be randomly chosen from a defined user bank of choices; selection change could be a function of transition from “music mode” to “no music mode”—back to “music mode” (auto detection and switching).

Aggregate down beat of music could be firmware derived; additional channel (or assignment of existing channel) could behave as aggregate “sub woofer” light display.

No limit to number of input channels means optical rhythm controller is fully compatible with surround multi-channel sound sources; including theaters.

Security system output device application: easy to turn on different color distributed lights that could have assigned meanings. Hearing impaired could enjoy understanding of alarm's severity.

DLM's could be configured to drive different sirens or different colored beacons/strobes as output warning devices.

Softened colors light behavior via optical rhythm controller application could substitute for abrupt warning lights (i.e. xenon strobe lights) that could otherwise trigger spastic/undesirable effects on people with physiological/psychological disorders (numerous types). Use could eliminate user's liability for those with possible convulsion sensitivities.

Robust frequency selective algorithms can manifest a dynamic frequency and amplitude transfer function.

The quantity of frequency channels within the audio band (20 Hz-20 KHz) can be user configurable in certain embodiments.

Each of the channel band pass filters can have static or dynamic upper and lower frequency set points in certain illustrative embodiments.

Each of the frequency channels can have static or dynamically adjusted upper and lower bound frequency band pass slope in certain illustrative embodiments.

The family of frequency bands may be statically or dynamically defined based on music or program material type in certain illustrative embodiments.

The family of frequency bands may be statically or dynamically defined as piece-wise continuous or can be contiguous in certain illustrative embodiments.

The family of frequency bands may be statically or dynamically defined to include the full human audio bandwidth of 20 Hz-20 KHz or limited to particular channel pass bands that manifest desirable frequency gaps, i.e., the optical output activity versus frequency may or may not have constant monotonicity.

The input signals may be simple or multiple channels; high levels, low levels, or any amplitude mix (per source).

The input signal(s) include wide amplitude dynamic range auto adjust such that millivolt signals and or high power signals (1 KW RMS) manifest comparable desired performance; simultaneously and in real time.

The input signal suite, albeit single channel monaural or multi channel surround sound, are statically or dynamically weighted in accordance with music types or audio program type via unique predefined tabled firmware. A non-predefined mode of operation may also be chosen, based on randomly selected variables in real time.

The randomly selected amplitude variable mode may further be programmed to change to a new/different randomly selected set of amplitude values in real time. A preprogrammed step change set of amplitude values, which can drive the random generator end game is also a robust feature.

A single set of assigned frequency band colored lights (or single lamp) require the optical rhythm controller to convert greater than one channel input internally to monaural in order that the aggregate music or program material can modulate each of the frequency channels colors at the correct time.

The optical light output per pass band filter will vary in intensity with or without attack and decay time involved as a parameter.

Music or program audio content may be selected to statically or dynamically vary the attack and decay times of the enabled optical channels.

Fast attack and much slower decay time (per channel) present the user/listener to “see” the soul of the audio input.

The “Soul” of the audio input can allow hearing impaired users to “feel” the source material and therefore allow their access to understanding and participating in the pleasure and joy of fellow listeners—which they may never have shared before.

When multiple input signals are supplied to the optical rhythm controller, preprogrammed weighting of each source before the aforementioned monaural conversion can be statically or dynamically selected.

The optical rhythm controller can have the desired unique capability to self calibrate and normalize the colored optical output maximum intensity. This human optical (light frequency) equalization permits each of the light colors/audio frequency sub-bands to have the same maximum brightness, independent of color. The optical rhythm controller automatically sets the bias output current per channel (keep alive power level).

The optical rhythm controller can dynamically inform itself, via current calibration feedback, regarding the quantity of colored lights connected (per channel). This unique feature allows “constant” optical behavior when the quantity of colored bulbs per channel are not equal.

An audio input multi channel digitally controlled color organ for output control.

An audio input multi channel digitally controlled color organ for output control including an automatic gain control for input line level conditioning.

An audio input multi channel digitally controlled color organ for output control including a multi-channel filter circuit for frequency band integration.

An audio input multi channel digitally controlled color organ for output control including a semiconductor output control circuit for AC line level control.

An audio input multi channel digitally controlled color organ for output control including a zero crossing detector for output synchronization.

An audio input multi channel digitally controlled color organ for output control including a means for dynamic specification of manual gain control.

### BRIEF DESCRIPTION OF THE DRAWINGS

These and other features and advantages provided in accordance with presently preferred exemplary embodiments of the invention will be better and more completely understood by referring to the following detailed description in connection with the drawings, of which:

FIG. 1 shows an exemplary illustrative non-limiting multicolored holiday light display that responds to sound by providing a pleasing visual effect that is synchronized to music;

FIG. 2 shows en exemplary illustrative preferred embodiment including separate audio processing and power switching modules that can be located remotely from one another;

FIG. 3 shows an exemplary daisy chaining arrangement;

FIG. 4 shows an illustrative block diagram of an exemplary audio processing module;

FIG. 5 shows an illustrative block diagram of an exemplary power switching module;

FIG. 6 shows an illustrative flowchart of an exemplary software-controlled audio processing arrangement;

FIGS. 7A-7C show an exemplary schematic circuit diagram;

FIGS. 8-9E show exemplary phase control;

FIG. 10 shows an exemplary composite filter frequency response;

FIG. 11 shows an example fast attack, dynamic (slow) decay characteristic; and

FIGS. 12A and 12B show example illustrative triac triggering characteristics.

### DETAILED DESCRIPTION OF PRESENTLY PREFERRED ILLUSTRATIVE, NON-LIMITING EMBODIMENTS

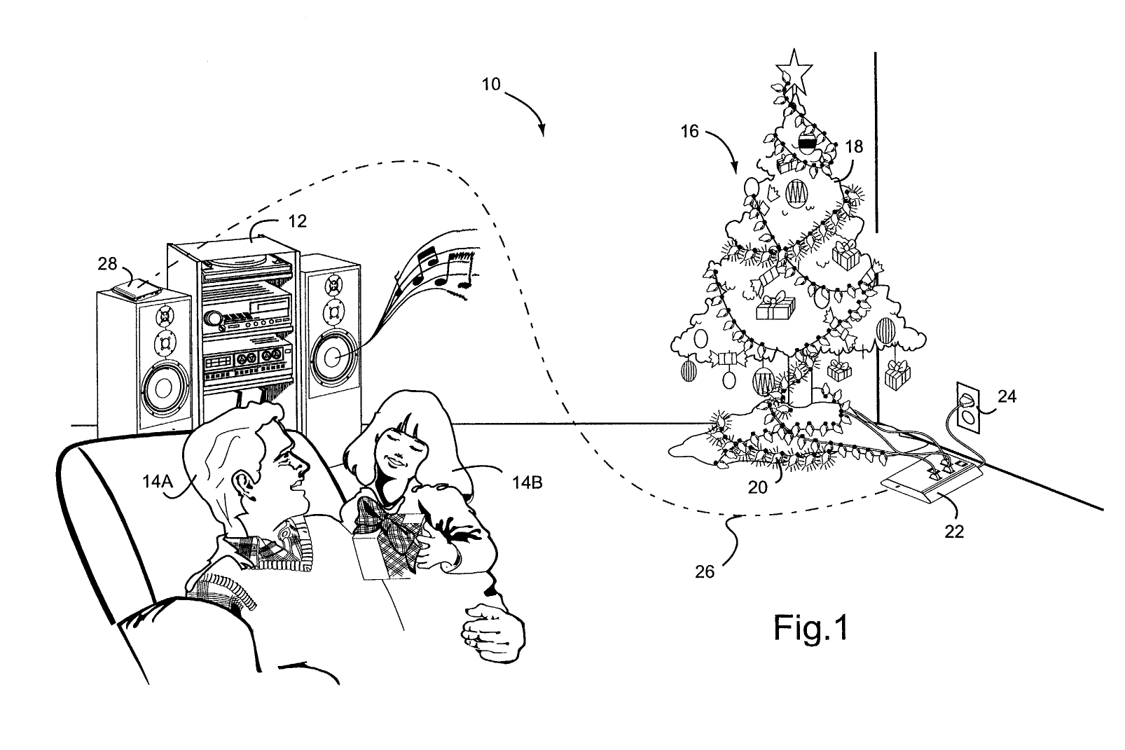

FIG. 1 shows an illustrative “light dancer” holiday light display system 10 provided in accordance with one aspect of a presently preferred exemplary embodiment of this invention. In the example shown, a source 12 of sound or music (e.g., a home stereo system, public address system, CD player, radio, television, amplified live sound microphone, satellite receiver, computer sound card, or any other sound source) generates sound that people 14 can perceive through their sense of hearing. A display 16 provides an indication that the people 14 can perceive with their sense of sight. The display 16 provides visual indications that are synchronized and responsive to the sound generated by sound source 12.

In the illustrative example non-limiting arrangement shown in FIG. 1, display 16 comprises a Christmas tree 18 strung with a plurality of differently-colored electric light strings 20. In the illustrative embodiment shown, for example, there may be four or five differently colored light strings (e.g., red, green, yellow, blue, white) all strung onto the Christmas tree 18. Equipment provided in accordance with the present invention causes the Christmas tree light display to provide a visual indication in response to sounds emanating from the sound source 12.

While the exemplary and illustrative arrangement shown in FIG. 1 provides a Christmas tree 18 light display, other types of displays are possible. For example, the electric light strings 20 may be supported by any sort of a structure and may be of any of a number of variations of different colors. Preferably, display 16 provides a spatially separated multi-colored light illumination display, but other variations are also possible. The electric light strings 20 could, for example, all be the same color, or they could be mixed colors. Different colored lights could be separately located or they could be co-located. It is desirable for each one of the differently colored light strings 20 to be independently switched and controlled, but other variations are also possible. The light display 16 shown in FIG. 1 is an indoor display, but it could instead be an outdoor display. Display 16 could be placed in a home, a shopping mall, a public place such as a church or park, or just about anywhere.

In the illustrative and exemplary embodiment shown in FIG. 1, the light strings 20 are connected to an illustrative switching module 22 that also may be referred to as a “distributed lighting module” (DLM). The switching module 22 is preferably connected to a power source such as a conventional 110 volt AC house wiring outlet 24. The switching module 22 independently controls a plurality (e.g., five) of power output channels to which may be connected to independent, differently-colored strings or individual electric lights. The switching module 22 controls whether the electric illuminating devices connected to it are on or off, and also controls the brightness of those devices. One can think of the switching module 22 as containing a plurality of fast-acting automatically-controlled dimmer switches—with the amount of dimming being specified by control signals provided to the switching module over a control link 26.

In the exemplary and illustrative embodiment shown in FIG. 1, an audio processing module 28 (which can also be referred to as an “optical rhythm module” (ORC)) provides switching control signals to switching module 22 over control link 26. In the example embodiment, the audio processing module 28 is connected (e.g., by cables in one embodiment, but other connections are also possible) to receive audio signals from a sound source 12. The audio processing module 28 processes this received audio, divides the audio into different frequency bands, and analyzes each of these different frequency bands independently to provide associated responsive switching control signals. The audio processing module 28 sends these switching control signals to switching module 22 over control link 26.

As the sound source 12 plays music, the audio processing module 28 analyzes the music and divides the music into a number of different frequency bands. The audio processing module 28 separately analyzes the amplitudes (i.e., strength) of the audio content in each of these separate frequency bands, and generates an associated control signal with predetermined attack/release characteristics. This control signal is applied over control link 26 to control the switching/dimming of a corresponding electrical switching output channel. In this way, different colored lights within lighting display 16 are controlled based on the amplitude of a corresponding spectral content of sound generated by sound source 12. The resulting multi-colored light display is very pleasing and relaxing to watch—and the synergy between the dancing multi-colored light display and the sound generated by sound source 12 provides an overall remarkable effect that is relaxing, interesting and allows one to closely follow the music being generated by the sound source 12.

In one particular exemplary arrangement, the overall system 10 operates by accepting signals from audio sound source 12 and separating them into four separate frequency channels that drive individual colored strings of light. The color bands may correspond, for example, to the following voice or orchestra ranges:

| | | | |
|---|---|---|---|
| Blue | Soprano voice | Violin-Piccolo | High frequency |
| Green | Alto voice | Flute-Viola | Second highest frequency |
| Yellow | Tenor voice | Trumpet-Trombone | Mid range frequency |
| Red | Bass voice | Tuba, string bass | Lowest frequency |

Frequency overlap is designed into the system in the exemplary embodiment to create a gentle “roll off” or fading off of color from one frequency band to the next. The volume, or loudness of sound in each frequency band controls the power output to each of the four strings of single-color lights. Because the volume and rhythm of the music controls the brightness and pulse of the lights, every song produces a unique and different visual impact. System 10 thus creates a new visual interest in the music whether produced by live choirs, instrumental groups, recorded sounds or the like.

Thus, for example, each time a flute plays a high note, green lights within display 16 may come on in an amount of illumination that is proportional to the loudness of the corresponding high-frequency note or sound. Similarly, each time a bass drum is struck or a tuba plays a very low note, red lights within display 16 may be illuminated with an illumination amount that is proportional to the loudness of the sound or note. Yellow and blue lights within display 16 may similarly become illuminated based on other frequency components of the sound being generated by sound source 12. The resulting dazzling, ever-changing, multi-colored light dance in synchronism with the sound being generated by sound source 12 is fascinating to watch, and provides a level of relaxation and interest beyond what may be obtained by conventional randomly-flashing or timed-sequence light displays.

In one exemplary illustrative embodiment, the correlation between the multicolored light display and audio effect of the music combines synergistically to provide almost a “sixth sense”. Different musical passages cause the light display to respond in different (and sometimes unpredictable but nevertheless correlated) ways to maintain interest. In the exemplary embodiment, the following non-limiting advantageous features contribute to the viewer/listener's enjoyment:

the light output tracks the non-linear responsivity of the human ear (e.g., based on a squared or other non-linear relationship);

light illumination decays in a dynamic, intelligent fashion based on a combination of a predetermined delay augmented by a dynamic decay factor which maintains interest (e.g., every decay can be a surprise) under a variety of ambient background illuminations (e.g., in both bright and dark rooms);

a “no music” detection mode provides some form of illumination when the music goes away for a predetermined time period; and

the system adapts automatically to a variety of different music levels without the need to twiddle with manual controls.

In the exemplary arrangement shown in FIG. 1, the audio processing module 28 and the switching module 22 are provided as separate modules that can be remotely located with respect to one another. Control link 26 is implemented in one exemplary embodiment as a conventional thin multi-conductor telephone cable that can be easily hidden beneath a carpet, strung within a wall, or disposed and run in any other convenient way that does not detract from the aesthetics of the display 16. In the illustrative embodiment shown in FIG. 1, the control link 26 could alternatively be implemented by a wireless link based on radio frequency (e.g., pulse code modulated FM or spread spectrum), infrared, ultrasonic or any other convenient wireless transmission mode.

In the illustrative embodiment shown in FIG. 1, the audio processing module 28 and the switching module 22 can be located remotely to one another so that the audio processing module 28 can be placed close to sound source 12 and the switching module 22 can be placed close to display 16. By providing remotely located modules, the amount of additional cabling is minimized. For example, in this illustrative arrangement, the various electric light strings 20 can be plugged directly into the switching module 22 without requiring any extension cords, adapters or the like. Although the switching module 22 is prominently shown in FIG. 1 for ease of illustration, it would typically be located behind the display 16 (e.g., hidden beneath an apron so that it is concealed).

While certain advantages are obtained by locating the audio processing module 28 remotely from the switching module 22 in the exemplary arrangement shown in FIG. 1, in other arrangements it may be desirable to co-locate these two units (e.g., by placing them within the same housing).

### Example More Detailed Module Arrangement

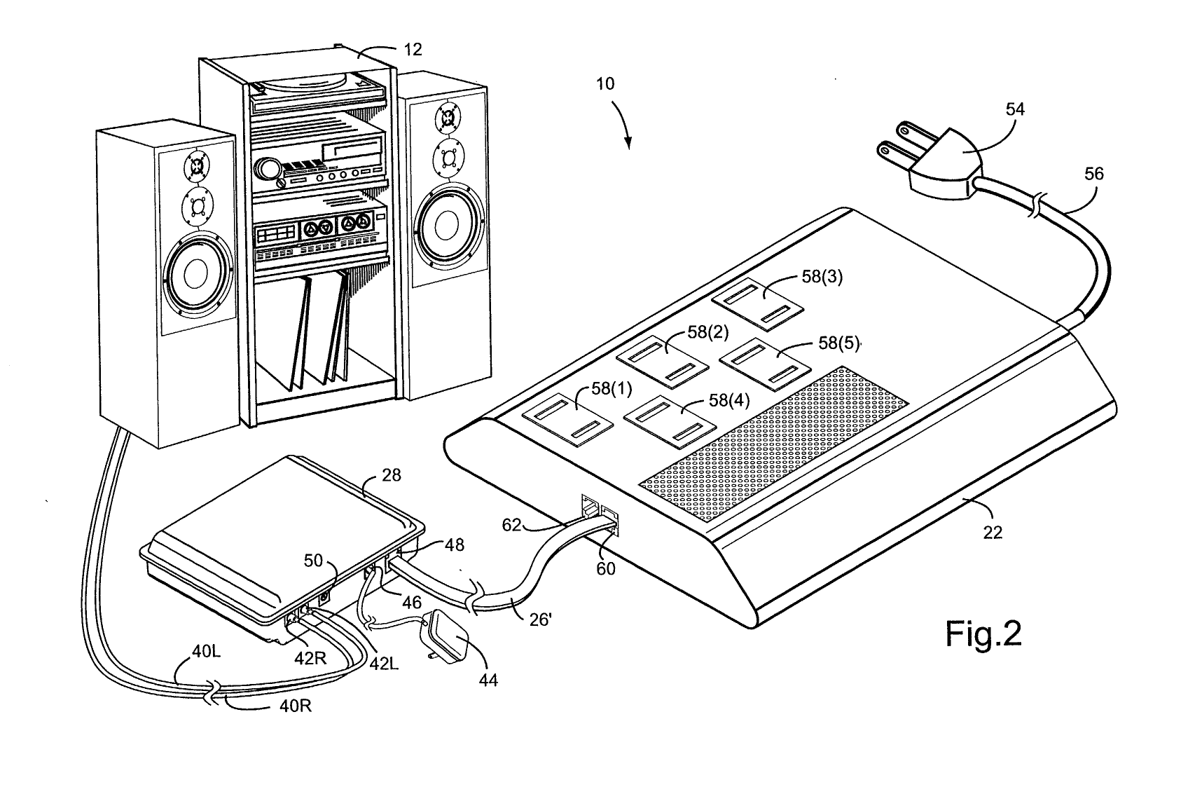

FIG. 2 shows units 22 and 28 in more detail. In this exemplary and illustrative embodiment, the audio processing unit 28 is connected to a sound source 12 via a pair of conventional left and right light-level audio cables 40 via conventional audio RCA jacks 42, for example. In this example embodiment, the audio processing unit 28 may receive power from a conventional power adapter 44 via a conventional 2.5 mm coax plug 46. A multi-pin output connector 48 may be used to connect to a cable 26′ that provides a multi-channel control link to the switching unit 22. An optional level adjustment 50 may be used to provide a “set and forget” line level adjustment to accommodate a wide variety of different sound source 12 output levels. Therefore, changing audio source volume control does not cause light intensity proportional change; the lights continue to operate within their optimum registration in one exemplary embodiment.

As shown in FIG. 2, the exemplary switching unit 22 may plug into a wall socket 24 via a conventional 2-prong or 3-prong 110 VAC power plug 54 and associated cable 56. The exemplary switching unit 22 further includes a plurality (e.g., 5 in this example) of switched power output sockets 58 for providing switch 110 VAC (house current) power to a corresponding plurality of electrically-powered illuminating light sources such as colored light strings. Switching unit 22 preferably has the form factor of a conventional power strip, and eliminates the need for splitters and extension cords that many people typically use to connect a large number of colored light strings. Briefly, the switching unit 22 operates by controlling the duty cycle of the power being applied to the different light strings so as to control their intensity at any given moment over a variable range from entirely off to entirely on to various different intensity levels therebetween.

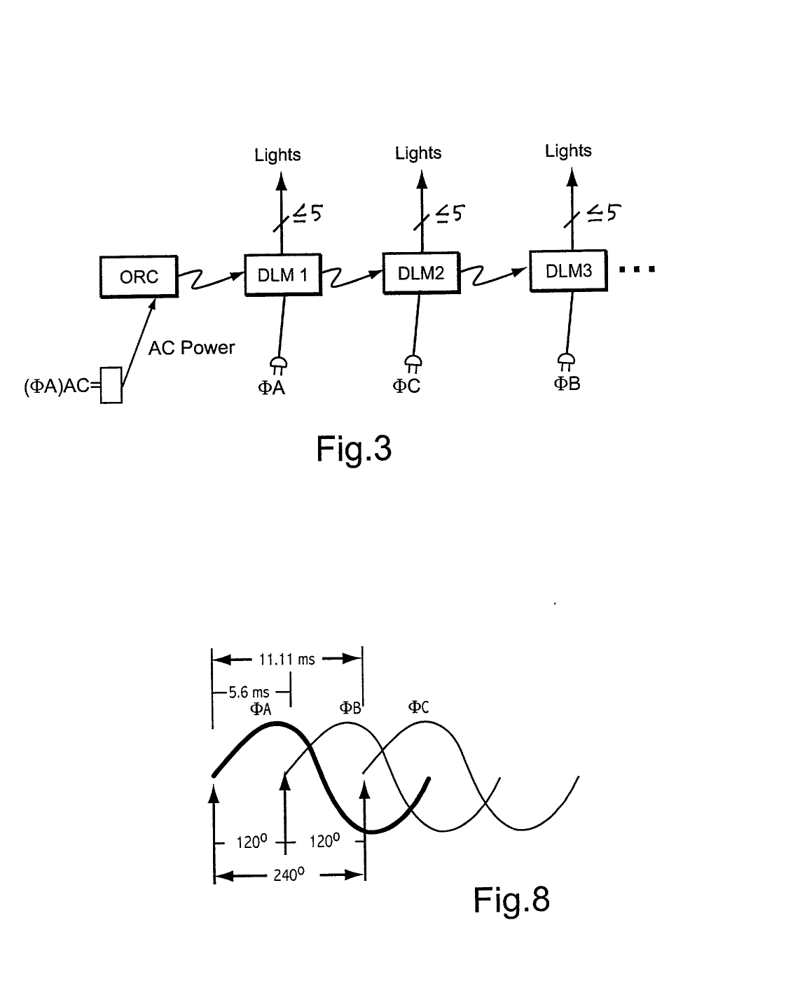

In the example shown, the control cable 26′ connects to switching unit 22 via a conventional multi-pin socket 60. In the exemplary embodiment, the switching unit 22 includes an additional socket 62 that can be used to “daisy chain” to another switching unit 22. Such “daisy chaining” may be used, for example, when providing a light display 16 that is spread over a wide area and/or has high current requirements (see FIG. 3). Any number of switching units 22 can be daisy chained together over any distance—for example, in one exemplary embodiment, up to five switching units can be daisy chained over a distance of 600′ to provide a distributed power switching capability all controlled by a common audio processing unit 28.

To connect the system 10 shown in FIG. 2, one may first connect the power adapter 44 to the power jack 46 on the audio processing unit 28 and plug the power adapter 44 into facility power output of 120 volts AC 60 Hz. A light emitting diode or other display (not shown) on audio processing unit 28 may illuminate to indicate that the unit is active. One may next connect the stereo audio source cables 40 to the RCA jacks 42 on the audio processing unit 28. These two jacks are for left and right channel signal inputs. The audio source 12 may be any audio source including, for example, a monaural live microphone that picks up audio emanating in the space in which audio processing unit 28 is placed. Next, one may connect the control cable 26′ to the control jack 48 on audio processing unit 28, and connect the other end of the control cable 26′ to the control jack 60 on power switching unit 22.

One may then plug in the power input plug 54 of switching unit 22 into a wall socket 24, and plug various light strings 20 into the switched output sockets 58 (or perform these two operations in reverse order if desired). An optional main power switch (not shown) disposed on switching unit 22 may be turned on to activate the light display 16.

In the exemplary embodiment, a miniature mode switch (not shown) on the front panel of audio processing unit 28 may provide four distinct switching positions corresponding to four different modes of operation when there is no audio input detected for a predetermined time period (e.g., 10 seconds). The four modes may function as follows:

| | |
|---|---|
| Mode 1 | Output channel 58(5) lights on continually |
| Mode 2 | All five channels 58(1)-58(5) are on continuously |
| Mode 3 | Channels 58(1)-58(4) are on continuously and |
| | the remaining channel 58(5) is off |
| Mode 4 | All channels 58(1)-58(5) are alternatively on and |
| | off in sequence for several seconds. |

The mode switch in this illustrative embodiment is thus used to program the system 10 to respond to “no music” conditions in a predetermined manner. “No music” behavioral modes different from those above are also possible in the event that audio processing unit 28 detects a “no music” condition for a predetermined time period.

### Example More Detailed Illustrative Embodiment

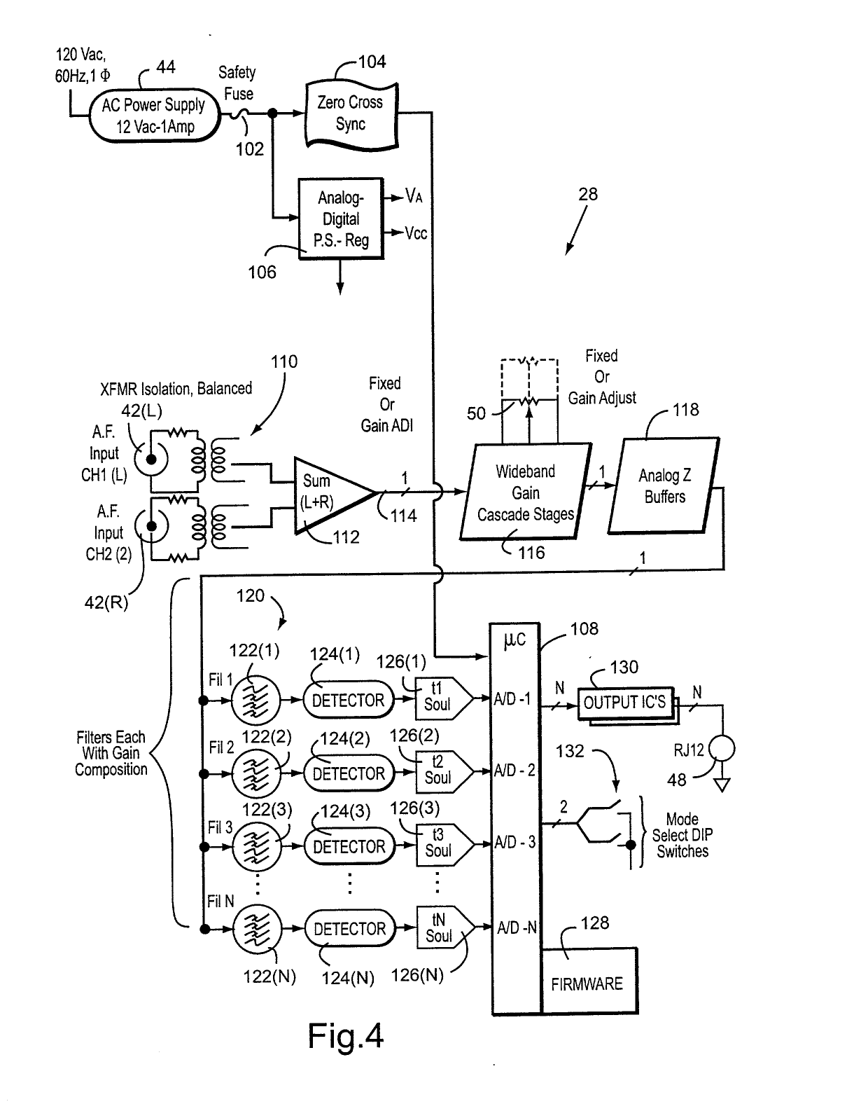

FIG. 4 is a block diagram of an exemplary design for audio processing unit 28. In this exemplary embodiment, the AC power supply 44 provides power via a safety fuse 102 to a zero cross sync block 104 and to a power regulator 106. Zero cross sync block 104 in conjunction with a software-controlled microcontroller 108 provides synchronization to accommodate different power phases within an extended (daisy chain) switched power network of multiple switching units 22 (see FIG. 3).

In the exemplary embodiment shown, the audio input jacks 42 are coupled to separate primaries of an isolation transformer 110, the secondary outputs of which are summed by an amplifier 112 to produce a monaural audio output 114. Typically, these two audio inputs will be left and right channels of a stereophonic sound source, but in other arrangements they could be provided by different independent sound sources. The mixed monaural audio output 114 is amplified by wide-band gain cascaded stages 116. The amount of amplification in one embodiment can be adjusted by operating an adjustment control 50—or in another embodiment this gain may be fixed. The amplified output is buffered by analog high impedance buffers 118 in the illustrative embodiment and then applied to a filter bank 120 comprising a number (e.g., 4) of corresponding audio band-pass filters 122 each with gain composition. The band-pass-filtered audio signals are detected by respective detectors 124 and then further processed by a resistor-capacitor (RC) time constant circuit 126 providing “soul” (e.g., hardware-fixed contribution of the dynamic attack/release characteristics in one non-limiting embodiment). The “soul” characteristics of each of the different filtered channels may be different and customized for the particular frequency range.

In the exemplary and illustrative embodiment shown, the detected, integrated, filtered audio outputs are input to respective analog-to-digital conversion channels of microcontroller 108. These channels convert each of the respective filter bank outputs into digital form for further digital processing in accordance with software control based in firm ware 128. The resulting output control signals are buffered by output buffers 130 and supplied to output connector 48. An optional mode switch 132 may be connected to a data input of microcontroller 108 to specify different operating modes (e.g., what to do in the event that the audio processing unit 28 does not detect any music for a predetermined time period).

The example arrangement shown in FIG. 4 provides a hybrid mixture of analog and digital signal processing. This provides certain advantages in terms of cost and efficiency. However, other alternative arrangements could provide an all-analog approach, an all-digital approach, or any mixture therebetween. For example, in one exemplary illustrative alternative arrangement, the output of summer 112 could be immediately converted into digital form and presented to a digital signal processor that performs all of the band-pass filtering and other processing. Such an arrangement could be quite cost-effective in a VLSI single chip design, for example. In another exemplary arrangement, microcontroller 108 could be eliminated and replaced with additional discrete analog and/or digital processing circuitry. Other variations are also possible.

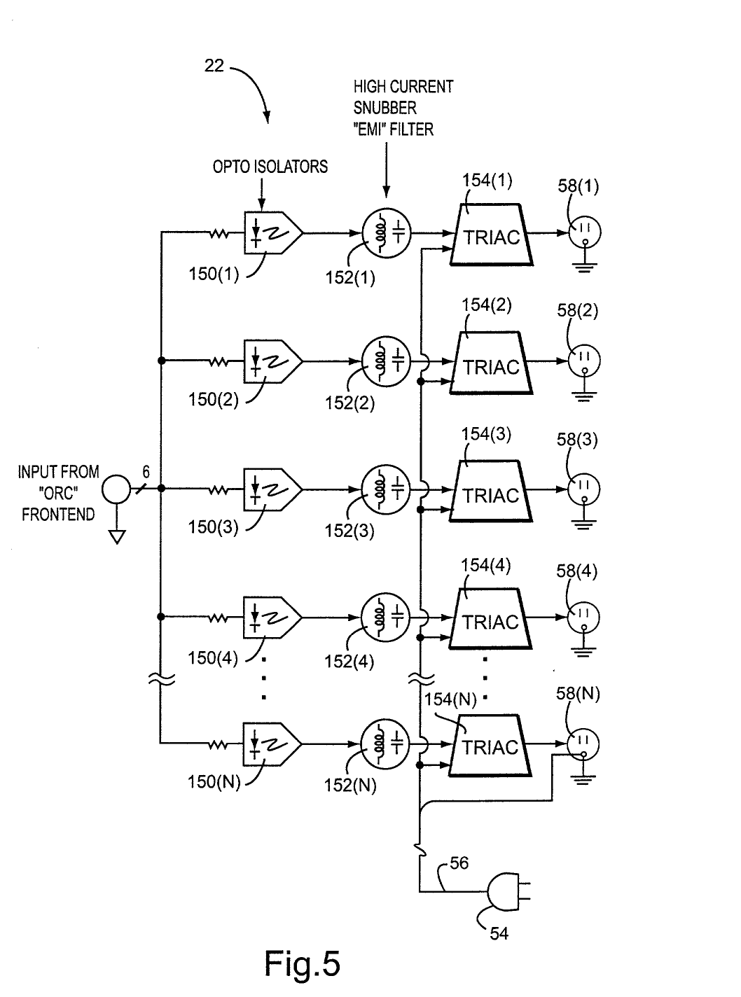

FIG. 5 shows an exemplary block diagram of switching unit 22. In this exemplary embodiment, the multi-channel output of audio processing unit 28 is separately processed with conventional opto-isolators 150 and filtered with electromagnetic interference filters 152 before being applied to a power switching device, such as, for example, a triac 154. The triacs 154 switch the AC power input to output power sockets 58 in response to the multi-channel input control. In the exemplary embodiment, there is a corresponding opto-isolator 150, filter 152, triac 154 and output socket 58 for each of the different band-pass filter arrangements 122, 124, 126 shown in FIG. 4. SCR's could be used in place of the Triacs if desired (with other corresponding changes in the non-limiting embodiment).

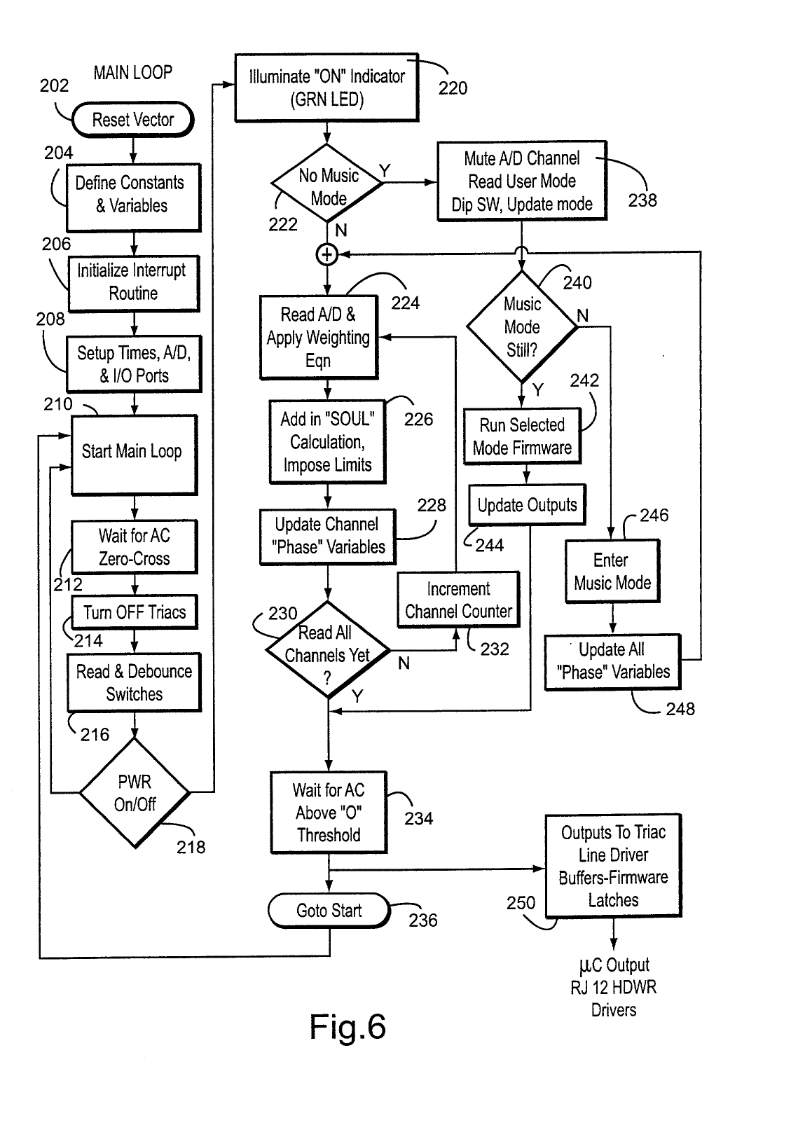

FIG. 6 shows an exemplary processing loop performed by microcontroller 108 in the illustrative embodiment. In the example shown, the microcontroller 108 performs a reset 202 and various other housekeeping tasks (e.g., defining constants and variables block 204; initializing interrupt routine, block 206; and setting set-up timers, analog-to-digital converters and input/output ports, block 208), before beginning a main loop 210. In the exemplary embodiment, microcontroller 108 then waits for an AC zero-crossing as detected by zero-cross sync block 104 (block 212) before turning off triacs 154 (block 214) and reading and debouncing switches (block 216). Assuming that the main power switch is “on”, the microcontroller 108 may illuminate a “power on” indicator (decision block 218, block 220) and then determines whether an audio input has been detected (decision block 222). If audio has been detected (“no” exit to decision block 222), the microcontroller 108 reads its analog-digital inputs and applies a weighting equation (block 224). It may then add in a “soul” dynamic addition to the preferred embodiment hardware decay bias via a real-time calculation, and impose limits (block 226). Microcontroller 108 then updates channel “phase” variables (block 228) and determines whether it has read all of the input channels (block 230). In the exemplary embodiment, microcontroller 108 repeats the process of blocks 224, 226, 228 independently for each of the various audio input band-pass channels (“no” exit to decision block 220, block 232), and continues doing so until all channels have been processed. The exemplary embodiment then waits for the AC power to cross above a zero threshold (block 234) before returning to start (block 236, block 210).

In the event that the microcontroller 108 detects a “no music” mode (“yes” to decision block 222), the microcontroller mutes the channel, reads the mode switch 132 specifying what to do in the event that no music is present (or executes a single “no music” mode operation in another exemplary embodiment)(blocks 238, 240, 242, 244), and then returns to wait for the AC to be above a zero threshold (block 234). If, on the other hand, the microcontroller 108 determines that music or sound is present, then the microcontroller enters the music mode (block 246), updates all phase variables (block 248), and returns to block 224).

Once the AC has risen above a “zero” threshold on its next cycle (block 234), the microcontroller 208 also performs a function of outputting control signals to the triac line driver 130 and associated latches (block 250).

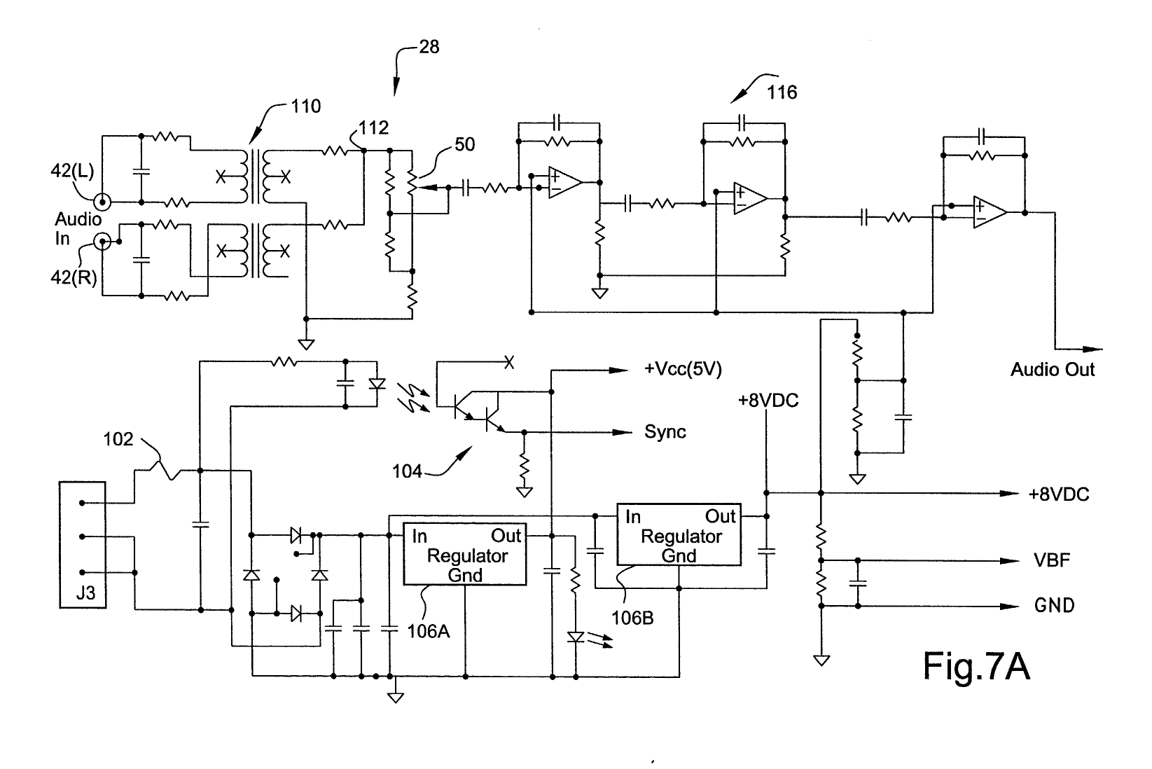

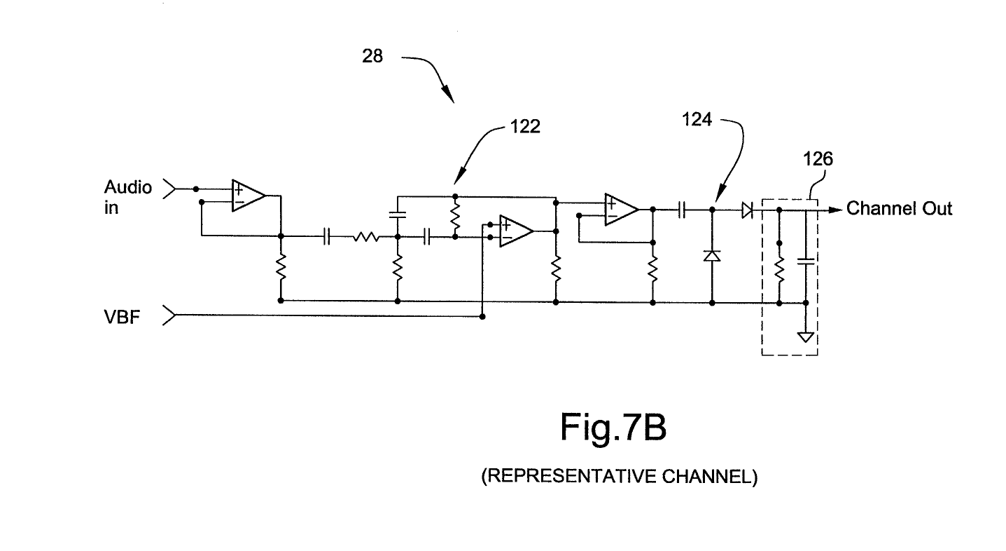

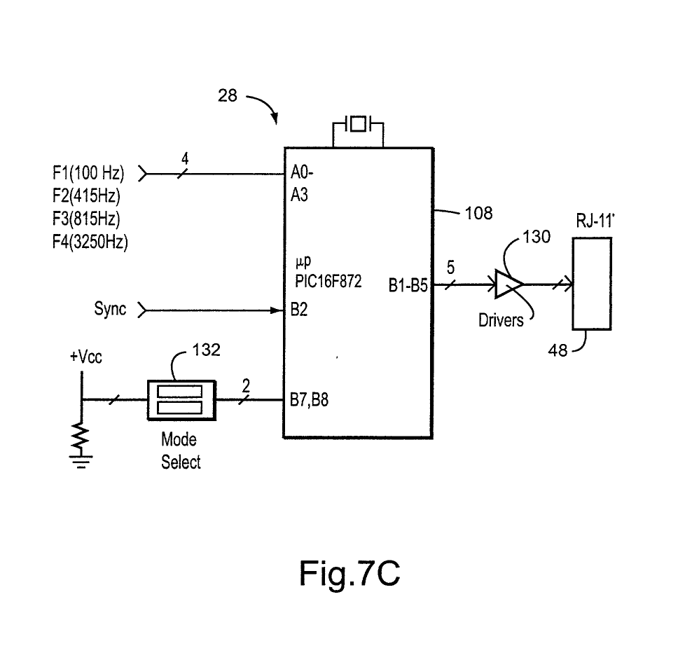

FIGS. 7a-7c show an example of a more detailed schematic diagram of the FIG. 4 audio processing unit 28. Corresponding components in the FIG. 28 block diagram are similarly labeled. FIG. 7a shows a exemplary audio front end (including input isolation, mixing and amplification) and power supply arrangement (including zero crossing AC sync detector) in more detail. FIG. 7b shows an exemplary filter channel (in one illustrative embodiment, all channels can use the same circuitry with the RC time constant 126 of each channel being customized to provide appropriate and desirable “soul” for that channel that is different from the “soul” of the other channels—“soul” in this context meaning the dynamic release/decay characteristics of the corresponding display triggering). FIG. 7c shows an exemplary connection for microcontroller 108.

Now that the overall system 10 has been described in some detail, we turn to specific descriptions of the more salient and complex details of the design in order to ensure that we are disclosing the “best mode” of our invention.

### Exemplary Phase Conversion Option

The optical rhythm controller front end 28, operating on, for example, phase A of a three phase commercial power system, will electrically cooperate with distributed light module 22 that is also on phase A. One example embodiment develops the microcontrollers zero crossing sync signal in the first distributed light module in the chain and feeds this required signal back to the optical rhythm controller 28 front end two additional cable conductors 26′ using an 8 conductor RJ45 connector/cable scheme. This configuration has the advantage of assuring the system that the first distributed light module, and likewise its connected incandescent loads, will always work together and properly. In this illustrative embodiment, a DC “brick” power supply 44 is utilized by the optical rhythm controller front end 28 since a line sync (AC) signal is not required to be developed internally. Another example embodiment uses an optical rhythm controller 28 developed sync signal and RJ12 6-conductor cable. In one example fan out configuration, each distributed light module 22 could each be connected to a different phase from that developed and fed back by the first distributed light module. However, this can possibly cause a sync signal undesired collision at the optical rhythm controller 28. Since each distributed light module 22 is preferred to be identical in one example embodiment, a work around solution could be a sync feedback toggle or other switch or control that could allow one and only one sync signal to be provided by the first distributed light module to the optical rhythm controller. This however doesn't solve the possible phase problem in the second and subsequent distributed light modules (distributed light modules numbers 2-5 may still not operate, or operate incorrectly, when each of their loads are referenced to a different power mains phase).

An additional embodiment provides a firmware solution in the optical rhythm controller. Since an inexpensive microcontroller may not have 10 additional output pairs (to allow 5 output channels on both phase B and C) and since the petite optical rhythm controller enclosure may not have enough available perimeter spare real estate for two additional RJ12 connectors, the notion of multiple optical rhythm controller phase outputs (3 independent RJ12 jacks) is probably not required. An illustrative derivative solution uses an additional phase delay switch that firmware could read. Upon a given user setting the pulse width output to the signal RJ12 jack could incur a 0°, 120° or 240° delay. The delayed pulse width output suite of signals could/would satisfy at least one distributed light module in the network of five output modules. Since this may use an additional optical rhythm controller three position switch, which might be difficult to include in the petite enclosure, the noting of an optional adapter “phase converter” embodiment is also possible.

### Exemplary Modular Design

In this further example embodiment, a small circuit board housed in a small self-contained enclosure (perhaps 3″×4″×4″) can be provided with DC power from a dedicated UL/CSA (safe) listed low current “brick” power supply. The circuit board in an example embodiment includes an inexpensive 16-pin PIC microcontroller, a line driver and passive line receiver circuit. One embodiment has a pair of RJ12 jacks; one input, one output that are clearly labeled. A three position user selector switch is also included to select between phases A, B and C (0°, 120°, 240°, respectively). This embodiment performs the aforementioned phase delays . Each can have the identical output current capacity as the optical rhythm controller and the ability to drive plural (e.g., 5) equivalent distributed light module/PPA loads. In one exemplary embodiment, an additional phase correction device can be used as a line repeater (e.g., to increase fanout) and/or as a simple phase changer. Alternatively, phase delay correction could be accomplished internally within the switching modules 22. Use of such phase correction can be used to synchronize multiple loads on different phases.

This allows a 600-foot RJ12 cable with connected distributed light module to operate on any power main phase properly. The installer simply installs the system inline with the input distributed light module cable and sets the phase switch for A, B or C. The correct setting will be easy to determine since incorrect phasing can prevent or distort distributed light module light output behavior. The correct setting is achieved when the subject distributed light module 22 operates as the previous one in the distribution (AULAN) network. Since the optical rhythm controller outputs are low voltage, low current in the example embodiment, the installation can occur when actual audio signals are dynamically operating. This arrangement can behave as a line buffer, albeit with or without a phase change. Five additional distributed light modules can be driven from a single PPA module in one exemplary embodiment. Theoretically, therefore, an unlimited number of distributed light modules and therefore incandescent lights can be operated from a single optical rhythm controller front end.

Some shopping malls are huge and seasonal installation needs to require the minimum man hours to configure. The exemplary system is modular so the installers can be creative as their mall administration requirements change over time; holiday to holiday, year to year, etc.

Some interested commercial customers may plan to utilize the system outdoors, as they will utilize environmentally sound NEMA enclosures for the non-weather resistant optical rhythm controller components. Installation in these cases will be utilizing best (SAFE) commercial practices.

It may be desirable to market their products in the European Union and internationally in general. With circuit adaptation to 230 VAC, 50 Hz operation, one certification testing to “CE mark” and “CB scheme” is possible for these markets.

The hardware detailed herein is segmented into three principle components. In one illustrative embodiment, the optical rhythm controller front end device is to be utilized with up to five distributed light module. Either type detailed in the drawings may be utilized, in any mix, with the “safe” low voltage parallel distributed (AULAN) interconnection. The distributed local area interconnection network output RJ12 connector on the optical rhythm controller is the intelligent source capable of driving any five distributed light modules within an aggregate (e.g., 600 foot) distance. It should be noted that there are, in an example embodiment, a pair of identical RJ12 jacks on each distributed light module. Either one may be considered the input, the remaining utilized for driving the next adjacent distributed light module in the specified configuration. The last distributed light module in the chain will not have its second RJ12 fan out jack utilized. In some cases, the final distributed light modules fallow RJ12 may have a low impedance termination network connected. This construct would be, for example, five 620 Ω resistor connected between each of the active low voltage lines and the common return in the final network connector. The five output lines are in one example, T²L (DC) levels; they are inherently safe since the optical rhythm controller source supply utilizes a UL/CSA listed isolation transformer/low current power brick. Each of the five active lines is distributed to as many as five identical distributed light module channels' opto-isolators, each requiring ≧1.13 VDC at 3.40 ma. The distributed light module interconnecting cables are inexpensive, reliable and easy to fabricate in situ at time of installation using inexpensive crimp tooling.

There are, in one example, two distributed light module types: one for high power use, and another for lower power use. The difference between the two distributed light module types is physical packaging and maximum load current capability. A 15 amp embodiment utilizes an all metal “power strip” style enclosure; the lower power 5A distributed light module is housed in 94VØ UL/CSA listed/required plastic enclosure. Both distributed light module types and optical rhythm controller front end embodiments should pass applicable U.S., Canadian and international safety standards. All three products are intended for indoor environment use.

The exemplary optical rhythm controller 28, has the following additional example attributes, characteristics and implementation/use advantages. Instead of packaging the optical rhythm controller and single distributed light module together in a common enclosure (which might under some circumstances lead to a myriad of cable tangles and the need to use extensive power strips to manage multiple loads on a single color light channel), we decided in one embodiment to physically separate the audio input connection to the optical rhythm controller from the high current AC load (layers) in order to minimize objectionable back fed EMI. Under some conditions, the conduction angle driven triacs within the distributed light module subsystem can contaminate the optical rhythm controller's driving source; albeit a line level or an amplifiers high level. Such EMI is objectionable because the optical rhythm controller driving signal is always being listened to, via parallel audio amplification and connected sources—line levels or speakers. Further the triac noise contamination can affect the optical rhythm controller—especially if the optical rhythm controller doesn't utilize a metal enclosure. Such noise, when fed back unintentionally, may cause latent incandescent lamp behavior which significantly reduces the product's effectiveness.

The example embodiment utilizes a dual-differential low impedance philosophy. Both input channels are independent and magnetically isolated from their driving sources and from each other. The optical rhythm controller is designed such that less than 1% of available drive power is required to direct the internal optical rhythm controller circuits. Exemplary connection configurations will be standard stereo, L&R. Other connection schemes could include two independent, mutually exclusive audio input sources (not necessarily co-located). This latter permits use of the optical rhythm controller product from either source without a need for swapping cables.

For example, in a shopping mall venue, the optical rhythm controller system may be operating from the local distributed overhead music. When a local light production is desired, for example physically near the Christmas tree in the Santa arena, music and audio source modulation is enjoyed from a local source—without any cable swapping. This is easily achievable when the overhead mall speaker zone has the remote ability to mute. For example, if during implementation of this two mutually exclusive input scheme, the mall audio infrastructure speakers can temporarily toggle from mute to operation back to mute (as in the case of a “lost child PA page”).

The optical rhythm controller channels preferably exhibit >28 dB audio channel separation in one example embodiment; thus, there is no worry about back feeding either source with the adjacent. A benefit is that when the audience becomes absorbed in appreciating the acoustic-optical color presentation, the auto mix of music and PA voice is easy for one to notice, since the light output behavior is intelligently based upon an internally derived aggregate of the inputs in real time. The required PA page could detract momentarily from the presentation, however, the effected parent will welcome the interruption.

The cooperation between the isolated transformer input signals, the new discrete analog processor and the intelligent microcontroller based digital “pulse width modulator” provides a totally unified philosophy in one embodiment. The input sources, after isolation, are fed to appropriate wide band amplification circuits. The amplitude dynamic range of the aggregate input with respect to proper light modulation is >50 dB. This is possible because the wideband amplifier input stages have a normalized output with respect to each of the color equalization channels. In other words, internal amplifier bandwidth-gain in one non-limiting embodiment is maintained extremely flat on a system per channel basis, and therefore total system basis, manifesting extremely accurate correlation between color channel amplitude and light intensity.

At time of manufacture, each of the four filters can be balanced for normalized amplitude behavior within their unique frequency bands. Use of 1% tolerance components in the optical rhythm controller permit inexpensive frequency-amplitude distortion, as the analog signal is being fed to the intelligent firmware driven resident microcontroller. Filter center frequency repeatability and output amplitude regulation are ±2% and ±1 dB, respectively. Further, the optimum center frequencies determined through 100's of hours of empirical experiments conducted with a custom optical rhythm controller reference system is preserved via use of now-inexpensive precision components.

The embodiment can provide plural (e.g., five) filter channels and corresponding independent distributed light module load channel outputs or fewer (e.g., 4) active color channel frequency filters in one example illustrative embodiment. One exemplary non-limiting embodiment has five output channels for connection of different colored incandescent lamps. The herein presented distributed light modules have maximum load capabilities of 1.8 kW and 600 W for 15A and 5A versions respectively (ref 120 VAC, 50 Hz mains) in one non-limiting exemplary embodiment.

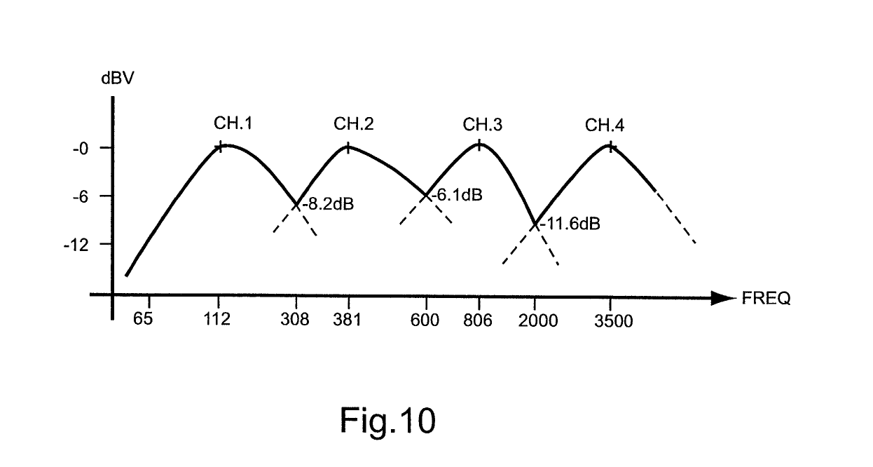

The four new center channel definitions in one non-limiting embodiment are 100 Hz, 415 Hz, 815 Hz and 3250 Hz (see FIG. 10). The particular overlap −6 and −12 dB frequency points are optimum and were determined empirically in the illustrative embodiment. The hardware circuit values in one exemplary embodiment reflect a per channel Q of 2.25. This optimizes the correlation between select color—its brightness and the simultaneous real time enjoyment of acoustic music. Each of the four frequency channels in this exemplary embodiment has a corresponding distributed light module output channel.

The fifth distributed light module output channel in the exemplary non-limiting embodiment is identical in its hardware to the other four triac output channels. This fifth channel is operable in any of the “no music” modes.

During the presence of music, four color channel outputs are available from the network of up to five distributed light modules. For instance, if five 15A distributed light modules are connected, a maximum of 9 kW of incandescent lights can be safely modulated; recall having an aggregate optical rhythm controller separation distance of 600 feet.

It is possible to provide user push buttons (manual) for mode select and gross amplitude scaling. However, in another exemplary embodiment, these function selection switches are deleted since these functions are automated (e.g., via firmware). It is also possible to provide an optional potentiometer for manual amplitude dynamic range centering. This illustrative non-limiting optional potentiometer cooperates with the robust firmware in the microcontroller based pulse width modulator in one exemplary embodiment. The potentiometer may be eliminated at time of manufacture, since fixed values can take the place of this analog front end voltage divider. The very wide dynamic range of operation, contained in the analog hardware unique cooperation with the optical rhythm controller firmware in the illustrative embodiment, makes this possible. The variable version lends itself to gross input amplitude adjustment between “line level input” and “high level” audio speaker input. The fixed resistor version has an identical amplitude dynamic range (>50 dB), however, its limits are factory optimized for typical mixing board outputs (i.e., Electrovoice, Peavy, etc.).

One example embodiment uses an “audio equalizer integrated circuit.” A further exemplary analog design is discrete with design control once each and every parameter and is implemented using low cost quad-operational amplifiers—which is also an improved cost effective approach and solution.

One example embodiment uses 120 VAC input mains directly. Another embodiment can employ an external AC adapter to internally develop a “power input zero crossing circuit” without the use of a cumbersome heavy gauge AC power cord and plug. It is desirable to provide an overall module that is physically compact; light in weight, manageable I/O cables—all being advantages for commercial or residential application integration where space and conductor routing are at a premium and easy, respectively. Many applications require optical rhythm controller co-location with complex audio mixing equipment—for example in a shopping mall Santa located presentation arena or in a home stereo context. Set up and breakdown time can be very important.

The following is a technical explanation of the optical rhythm controller-distributed light modules triac triggering. This brief theory of operation overview is intended to be of value in demonstrating the unique approach and parametric tradeoffs made in the illustrative, non-limiting but exemplary embodiment.

### Load Switching Theory of Operation

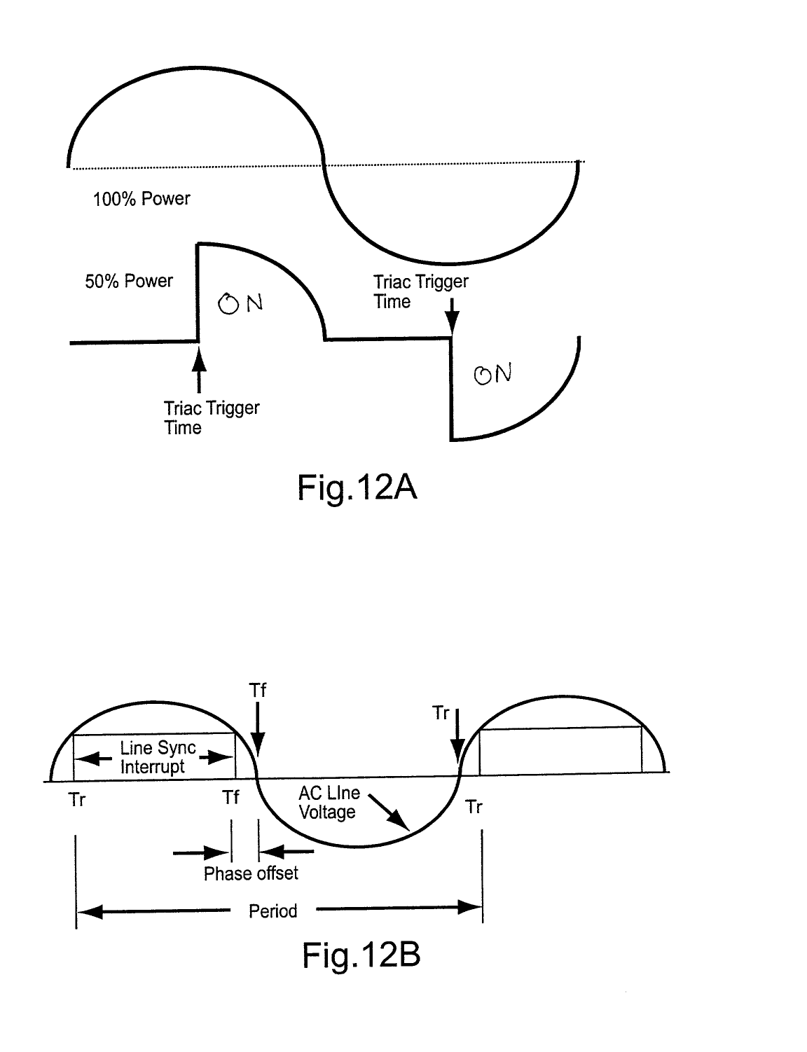

Triac triggering in the exemplary embodiment is based on pulse width modulation. The brightness of the lights is controlled by turning the light on for only a portion of each half of the 60 Hz power line cycle. For half power, the light would thus be on for half of each half-cycle. See FIG. 12A.

Once a triac gate has been triggered, the triac remains “on” after the gate trigger current is removed until the current through the triac load drops below a hold-in value. This hold-in current varies considerably over temperature, and varies from device to device. For all practical purposes, the current is in phase with the line voltage for lamp loads, so the turn-off point of the triac will be very close to the zero voltage crossing of the power line.

Since the triac will automatically turn off every zero crossing, the trigger must be reapplied every half-line cycle. The power line frequency determines the fastest rate we can change the brightness. No matter how fast we sample the A/D, or crunch numbers, we are limited in one illustrative embodiment to changing the brightness once per half power line cycle. We set the non-interrupt-driven portion of the software to synchronize with the power line so it is making decisions on the triac brightness for the next half power line cycle during the current half cycle.

The basic thing the software does in the illustrative embodiment is to control the brightness of each of the five lamp loads. Since we are using a low-cost (e.g., 8 bit) processor in one exemplary embodiment, it is very convenient to represent brightness levels in an 8 bit value—giving 256 levels of brightness. These brightness levels are essentially trigger times for the triacs. A brightness of “255” would trigger the triac as soon as possible after the power line zero crossing. A brightness of “0” would trigger close to the end of the half-cycle, and “128” ideally would be about half way.

With a 4.0 MHz processor clock and 32:1 prescaler (set by OPTION_REG), TMR0 increments once every 32 uS. 32 uS×256=8.192 mS which is a range that fits nicely within each 8.33 mS half-line cycle. The software uses TMR0 to generate an interrupt each time a triac is to be triggered. Since TMR0 generates an interrupt only when it rolls over from 255 to 0, the software must set TMR0 to a value that causes rollover when the next triac trigger is desired.

TMR0 was the selected interrupt to generate the triac trigger interrupt instead of a TMR2 to PR2 match, or CCP in the exemplary embodiment because every microchip processor with A/D converter has TMR0, while only the newer and higher end parts have TMR1 and TMR2. The goal has been to keep this software so in the non-limiting embodiment it can work in any of the low end processors with a minimum of changes needed.

Every half-line cycle, the illustrative software determines brightness levels for each triac and sets these values in a sorted table (named Time0, Time1, Time2, Time3, Time4). The values are sorted so Time0 is always brightest. Another table is set up (Out0, Out1, Out2, Out3, Out4) to contain which triac to trigger at each of the corresponding times. At each zero crossing, the values in TimeX are used to calculate the values to add to TMR0 to trigger interrupts at the desired times. We add values to TMR0, instead of writing values to TMR0 so if the interrupt service was delayed (by servicing another interrupt), the delay will only affect the timing of the one triac trigger and not push later interrupts back.

One version of the illustrative software keeps gate trigger applied for only 100 uS, which was the “maximum” time specified on the optotriac to ensure the optotriac fired. This avoids the need to generate an interrupt to turn off the triac triggers before the zero crossing, and does not require very much current to be available on the 5V supply to keep a triac trigger active. One possible issue with this approach is that it is possible that the lights may suddenly get dim when the triac was triggered soon after the zero crossing. The lights might not provide enough current at the early part of the line cycle to keep the triac held in.

Another exemplary version of software releases the triac gate triggers just before zero crossing. The time for triac gate release is set by the “MinOn” constant. “MinOn” is the minimum TMR0 counts the software will attempt to trigger the triac before the zero crossing. The Triac gate is released 3 TMR0 counts after the “MinOn” value. This should release the triac triggers 600-550 uS before the zero crossing.

We should be careful in one non-limiting approach to release the triac trigger before the zero crossing. Very dim lights would normally trigger on just prior to zero crossing. If the time or phase reference is not accurate, the triac trigger may not be released before the zero crossing where the triac would remain latched on for the other half power line cycle. This would result in a very dim light suddenly becoming bright. To address this issue, it is possible to include “pseudo” zero crossing references to the software instead of using the line sync interrupt directly.

The exemplary optical rhythm controller schematic is the analog circuit's processing output to the microcontroller A/D inputs (4 channels in one embodiment). Study channel #1 (100 Hz); AC to DC (detector) is accomplished by D2 and D3. In the illustrative embodiment, the parallel combination of RC network create the unique decay hardware time constant in the optical rhythm controller; referred to as “soul.” Soul is the relatively quick attack (turn on time) and the tightly calibrated decay time (turn off via dim time). The system aggregate “soul” can be determined empirically. The channel #1 detection and time constant circuit is identical to the other channels. In the exemplary embodiment, the hardware “soul” comprises the majority of the decay time required, however, the firmware augments this required minimum in one non-limiting arrangement. The additional time decay component of the desired “soul” is a strong function of a channel filter amplitude at any given time—also influenced by how quickly the magnitude of the slope continues to fall. The wideband cascaded amplifiers that parallel drive the buffered filters in one illustrative embodiment are precisely gain-at-peak frequency balanced with respect to the other filter channels. This ensures that the microcontroller's input A/D's will track, precisely, with the same algorithm implemented. The analog processing between input transformers and A/D inputs are coherent over the full frequency range of the optical rhythm controller. More specifically, over the dynamic range of input (≧50 dB) signals the analog processing circuits never go into clipping (on their way to the A/Ds).

### Triac Trigger Point Vs. Light Voltage

The following table shows exemplary calculated RMS voltage for each available triac trigger point, based on 120 VAC input and ignoring the voltage drop across the triac in the on state. Also included are meter readings from an “averaging” type digital volt meter, at several points. Most meters really “average” voltage, rather than provide true RMS. Our experience with so-called “true RMS” meters is they are accurate as long as no DC bias is present in the signal:

$${V}_{R M S} = {V}_{P} \sqrt{\frac{1}{2} ( 1 - \frac{T}{P} + \frac{1}{2 π} sin ( 2 π \frac{T}{P} ) )}$$

where V_{P}=Peak voltage; T=Time triac is on; P=Period of half-line cycle (8.33 mS)

### Exemplary Determination of Power Line Zero Crossing

The exemplary hardware provides a line sync signal on the processor's external interrupt pin. This line sync signal comes from an optoisolator with the LED driven from the secondary of a transformer driven by the AC power line. The LED takes some amount of current before it turns on the optoisolator's output transistor, so the line sync rising edge will always be delayed by some amount due to the optoisolator's threshold. The same is true of the falling edge. The falling edge will occur prior to the actual zero voltage crossing.

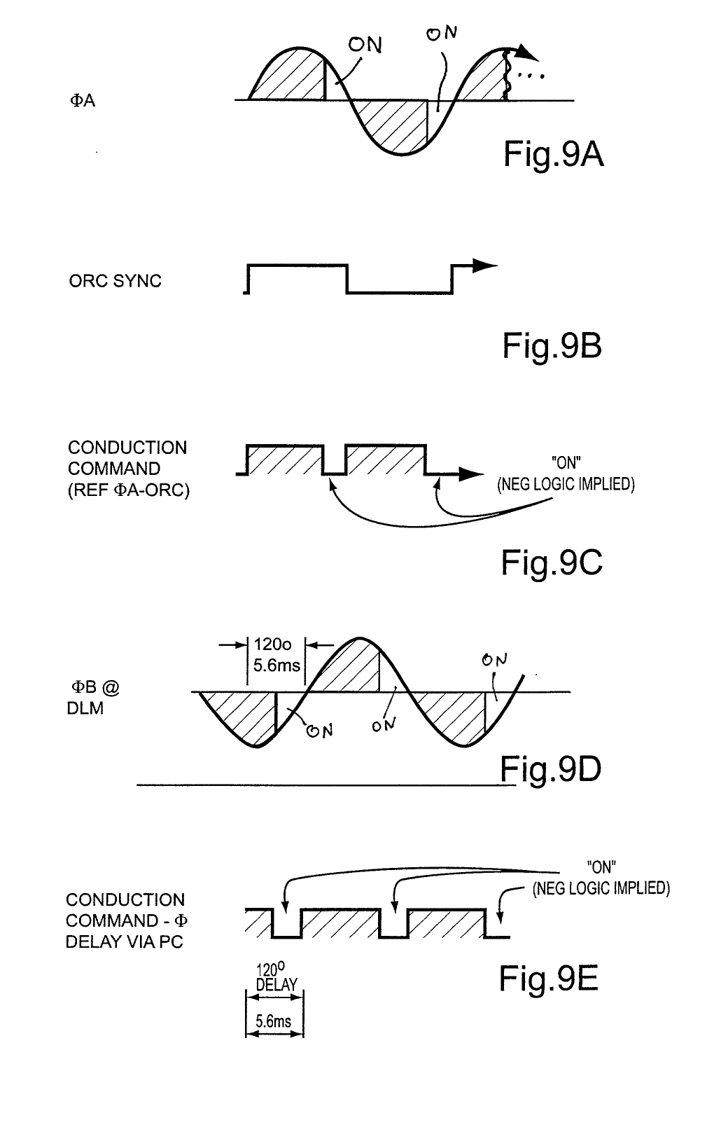

One exemplary version of the software includes a simple offset to the triac trigger times for the half line cycle after the falling edge. The offset time was determined by trial and error, and the positions of the line sync interrupts are likely to vary with line voltage and optoisolator thresholds in one exemplary embodiment (see FIGS. 8 and 9A-9E).

Another exemplary version of the software calculates where the zero crossing ideally should occur based on the line frequency and the time the line sync interrupt is high. The power line period is computed by a moving average of the time between rising line sync interrupts.

In this exemplary non-limiting version, the microprocessor's internal timer 1 (TMR1) is allowed to free-run, incrementing once per instruction cycle. With a 4.0 MHz clock, each count of TMR1 is 1.0 uS. When the line sync interrupt occurs, the interrupt service routine stores the value of TMR1 in variables Tr (TrH and TrL) for rising edge or Tf (TfH and TfL) for falling edge. The ideal zero crossing times are then calculated and the Capture/Compare module 1 is used to generate interrupts.

An illustrative phase offset can be calculated by:

$$PhaseOffset = \frac{\frac{Period}{2} - ( {T}_{F} - {T}_{R} )}{2} .$$

This phase offset is compared to the actual difference between the falling line sync and the generated Compare module interrupt. The timing of the next rising zero crossing interrupt is adjusted up to +/−100 uS to bring the pseudo zero crossing reference in phase with the actual zero crossing.

Triacs are prevented from running for the first 2 seconds after power is applied to allow the “zero crossing” interrupt to sync phase with the power line.

Using TMR1 and CCP1 hardware conflicts with keeping the software able to run on any microchip processor with A/D in one exemplary embodiment. However, the lowest cost processor with A/D at this time is the 18 pin 16C712 that does have TMR1 and CCP1. Other specific designs will certainly have different constraints and requirements.

### Exemplary “Soul” Decay Time

We provide two means for adjusting the “soul” in software in our illustrative embodiment. The first means is a “delay” value. This is the number of half-line cycles (8.3 mS) that the software will maintain the triac at the peak value before reducing its brightness. Having some software delay before allowing dimming helps reduce “nervousness” in the lights. The delay adjustment constant is labeled “Soul_Time”.

A second exemplary means for adjusting “soul” is the rate the output is allowed to decay each half line cycle after the delay time. This value is the amount to reduce the triac time lookup table index each half line cycle.

One exemplary embodiment can delay the actual triac trigger time rather than the index to the lookup table. This will work fine for mid-brightness, but might provide much too slow of a decay on the bright peaks.

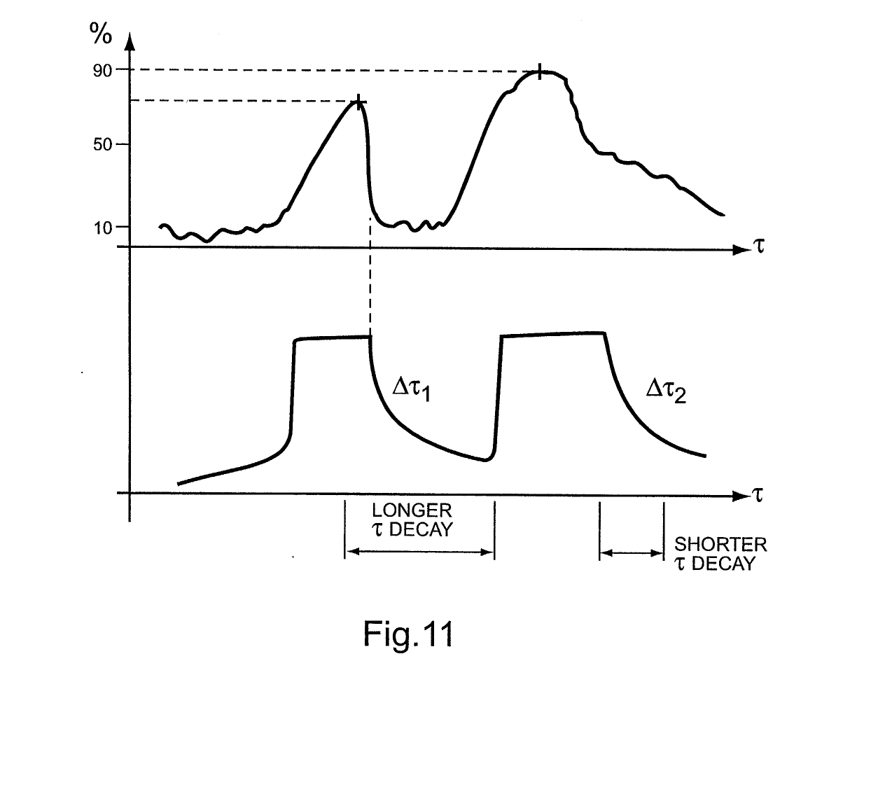

The exemplary software allows separate delay and decay constants for each of the 4 music triacs. See FIG. 11 for an exemplary illustration of the (inverse) correspondence between music note release and light display release in one exemplary embodiment

### Mapping A/D Values to Triac Trigger Times

The following is an illustrative Table of desired values for mapping A/D values to triac trigger times:

| | Vin (rms) | Vout | % Vout | Pwr Out - | % Pwr |
|---|---|---|---|---|---|
| Reference | (a/d) | DLM-rms | DLM | Watt | Output |
| 1 | 0.30 | 35 V | 29% | 2.4 W | 10% |
| 2 | 0.60 | 49 V | 41% | 4.8 W | 20% |
| 3 | 0.90 | 60 V | 50% | 7.2 W | 30% |
| 4 | 1.20 | 69 V | 58% | 9.6 W | 40% |
| 5 | 1.50 | 77 V | 65% | 12.0 W | 50% |
| 6 | 1.80 | 85 V | 71% | 14.4 W | 60% |
| 7 | 2.10 | 92 | 76% | 16.8 W | 70% |
| 8 | 2.40 | 98 | 82% | 19.2 W | 80% |
| 9 | 2.70 | 104 | 87% | 21.6 W | 90% |
| 10 | 30 . . . | 120.0 | 100% | 24.0 W | 100% |

These exemplary values are mapped, in one exemplary embodiment, to a look-up table based on DVM readings in the voltage table above. A scaled version of this table can be used for automatic gain control software to place the maximum output at 255 instead of about 154 in one non-limiting example. Note that in the table above, the “minimal” current drive is 10% of maximum as opposed to zero. In the exemplary illustrative non-limiting embodiment, the triacs are not entirely turned off and thus continually apply a minimal level of current to the filaments of an incandescent light string in order to increase filament longevity and provide a more instantaneous response

### Exemplary Automatic Gain Control

The term “automatic gain control” typically means that all input signals within a specific amplitude range will be equally amplified to manifest an output level of a defined magnitude. Automatic gain control is therefore often a misused term. Functionally, let automatic gain control be “DAT0 TUMA.” Let DAT0 TUMA represent the accurate performance synonym needed for optical rhythm controller discussions, explanations. DAT0 TUMA≡“dynamic audio to optical transformation using moving average”. A wideband, flat, unfiltered channel can be gain normalized and fed to the 5th (currently unused) A/D converter in the microcontroller. The need for an additional unique (e.g., fifth) channel dissolves when filtered channels #1-4 data could be used for conversion to information regarding “no music” status, overall amplitude, etc.

Automatic gain control is useful because it provides wide dynamic range to accommodate a wide range of different input levels, but it can potentially be a difficult aspect because of the subjective nature of what makes the lights pleasing.

In one illustrative embodiment, we simply multiply the actual A/D reading by a gain factor in software. The gain is a fixed-point number where the integer portion runs from 0 to 15, the fractional portion from 0 to 15/16ths in 1/16 increments in one non-limiting example.

Gain can be based on any number of different factors including for example:

moving average of the 4 music channels;

moving average of only the highest of the four music channels;

moving average of a fifth wideband channel; or other factors.

Using the moving average of only the highest value on any channel provides certain advantages. The inputs spend a considerable portion of their time near zero, regardless of volume level. The peaks really give more of an indication of volume level than an overall average.

The gain can be calculated by Gain=“Fudge”/Average Peak where “Fudge” is a constant. Larger value of “Fudge” makes the gain larger, therefore the average brightness higher.

We can run a moving average of Gain to allow the lights to adapt to quiet and loud portions of music in 2-3 seconds.

Another exemplary automatic gain control can use an approach based on determining the maximum peak read, then scaling A/D inputs as a ratio to that peak instead of multiplying by a gain. This may produce a less satisfying response to certain music but might be acceptable in some situations and contexts.

### Example Calculation of Moving Averages

The illustrative software sometimes calculates “moving averages.” However, in the example, these are not true moving averages. A true moving average would sum the last “n” samples and divide by “n”. This requires a huge amount of storage for samples to have a long time constant. Instead, we can use the simplest form of a tap IIR digital filter. Equation is:

Y(n)=A*X(n)+B*Y(n−1)

where Y(n) is the output of the filter, X(n−1) is the input sample, Y(n−1) is the previous output of the filter, and A and B are scaling factors.

For unity gain, choose B=(A−1)/A. The response to a step change is similar to an R-C filter with a time constant of 1/A sample periods.

We can use A=1/256 and B=255/256 to make the filter trivial to calculate. This takes only eight instructions and 2 bytes of storage for 8 bit samples. Let the high order byte by the integer portion of the output, and the low order byte be the fractional portion of the output. The (A−1)/A*Y(n−1) term is simply the high order byte subtracted from the 16 bit filter output. The A*X(n) term is simply the 8 bit sample data added into the 16 bit output term. When using the “output” of the filter for other calculations, just use the high order byte since it is the integer portion of the output. With A=1/256 and a sample frequency of 120 Hz, the time constant is just over 2 seconds.

One should be careful to sample at least twice (preferably 4 times) faster than the highest frequency component in the input sample to observe the Nyquist Theorem.

After intelligent “soft optical start” (after entering the valid music mode) in the exemplary embodiment, the light channels begin correct frequency/intensity ratio operation/correlation with continual moving time history evaluation. The moving time history integration interval has been optimized at approximately 3 seconds in the exemplary embodiment. This is not an aggregate evaluation in the illustrative embodiment; it is performed on a peak amplitude per frequency channel basis. Outputs, from each of the four integrated real-time frequency channels are compared to the current value. The instantaneous loudest audio frequency channel is utilized to establish the 100% light operating “Q” point. This current amplitude dominant channel data is used to simultaneously and proportionally ratio the less intense channels to their corresponding optical intensities.

The currently selected single reference peak amplitude channel at any moment may become less dominant then say an adjacent channel during a subsequent next integration interval. The new channel becomes the new revised reference. Stated differently; the peak of any channel is always being compared as firmware seeks out the loudest reference point the artist had intended. The newest reference is again stored, used for proportional threshold tracking for all channels, while continued seeking/amplitude comparing ensues. Most audio sources, including say a CD, establish a maximum audio loudness peak for the entire CD. This is a practical observation that makes this stored peak threshold assignment to 100% work so well in the illustrative embodiment.

As a certain song comes to an end and its amplitude intentionally decreases, the light channel outputs become quite dim compared to the peak value currently stored. The light output from the analog filter channels occur in the voltage domain. Firmware is arranged so that all voltage comparisons are converted via a squared “power” relationship. See the following table:

| Time value | Triac Trigger Time (mS) | RMS Voltage | DVM Measure |
|---|---|---|---|
| 1 | 8.16 | 0.9 | |
| 2 | 8.13 | 1.2 | |
| 3 | 8.10 | 1.5 | |
| 4 | 8.06 | 1.8 | |
| 5 | 8.03 | 2.1 | |
| 6 | 8.00 | 2.5 | |
| 7 | 7.97 | 2.8 | |
| 8 | 7.94 | 3.2 | |
| 9 | 7.90 | 3.6 | |
| 10 | 7.87 | 4.0 | |
| 11 | 7.84 | 4.4 | |
| 12 | 7.81 | 4.9 | |
| 13 | 7.78 | 5.3 | |
| 14 | 7.74 | 5.8 | |
| 15 | 7.71 | 6.2 | |
| 16 | 7.68 | 6.7 | |
| 17 | 7.65 | 7.2 | |
| 18 | 7.62 | 7.7 | |
| 19 | 7.58 | 8.2 | |
| 20 | 7.55 | 8.8 | |
| 21 | 7.52 | 9.3 | |
| 22 | 7.49 | 9.8 | |
| 23 | 7.46 | 10.4 | |
| 24 | 7.42 | 11.0 | |
| 25 | 7.39 | 11.5 | |
| 26 | 7.36 | 12.1 | |
| 27 | 7.33 | 12.7 | |
| 28 | 7.30 | 13.3 | |
| 29 | 7.26 | 13.9 | |
| 30 | 7.23 | 14.5 | |
| 31 | 7.20 | 15.2 | |
| 32 | 7.17 | 15.8 | |
| 33 | 7.14 | 16.4 | |
| 34 | 7.10 | 17.1 | |
| 35 | 7.07 | 17.7 | |
| 36 | 7.04 | 18.4 | |
| 37 | 7.01 | 19.0 | |
| 38 | 6.98 | 19.7 | |
| 39 | 6.94 | 20.4 | |
| 40 | 6.91 | 21.1 | |
| 41 | 6.88 | 21.8 | |
| 42 | 6.85 | 22.4 | |
| 43 | 6.82 | 23.1 | |
| 44 | 6.78 | 23.8 | |
| 45 | 6.75 | 24.6 | 16.2 |
| 46 | 6.72 | 25.3 | |
| 47 | 6.69 | 26.0 | |
| 48 | 6.68 | 26.7 | |
| 49 | 6.62 | 27.4 | |
| 50 | 6.59 | 28.2 | 18.9 |
| 51 | 6.58 | 28.9 | |
| 52 | 6.53 | 29.6 | |
| 53 | 6.50 | 30.4 | |
| 54 | 6.46 | 31.1 | |
| 55 | 6.43 | 31.9 | |
| 56 | 6.40 | 32.6 | |
| 57 | 6.37 | 33.4 | |
| 58 | 6.34 | 34.1 | |
| 59 | 6.30 | 34.9 | |
| 60 | 6.27 | 35.6 | 24.0 |
| 61 | 6.24 | 36.4 | |
| 62 | 6.21 | 37.2 | |
| 63 | 6.18 | 37.9 | |
| 64 | 6.14 | 38.7 | |
| 65 | 6.11 | 39.5 | |
| 66 | 6.08 | 40.3 | |
| 67 | 6.05 | 41.0 | |
| 68 | 6.02 | 41.8 | |
| 69 | 5.98 | 42.6 | |
| 70 | 5.95 | 43.4 | 30.0 |
| 71 | 5.92 | 44.1 | |
| 72 | 5.89 | 44.9 | |
| 73 | 5.86 | 45.7 | |
| 74 | 5.82 | 46.5 | |
| 75 | 5.79 | 47.3 | |
| 76 | 5.76 | 48.1 | |
| 77 | 5.73 | 48.8 | |
| 78 | 5.70 | 49.6 | |
| 79 | 5.66 | 50.4 | |
| 80 | 5.63 | 51.2 | 36.1 |
| 81 | 5.60 | 52.0 | |
| 82 | 5.57 | 52.8 | |
| 83 | 5.54 | 53.5 | |
| 84 | 5.50 | 54.3 | |
| 85 | 5.47 | 55.1 | |
| 86 | 5.44 | 55.9 | |
| 87 | 5.41 | 56.7 | |
| 88 | 5.38 | 57.4 | |
| 89 | 5.34 | 58.2 | |
| 90 | 5.31 | 59.0 | 42.5 |
| 91 | 5.28 | 59.8 | |
| 92 | 5.25 | 60.5 | |
| 93 | 5.22 | 61.3 | |
| 94 | 5.18 | 62.1 | |
| 95 | 5.15 | 62.8 | |
| 96 | 5.12 | 63.6 | |
| 97 | 5.09 | 64.3 | |
| 98 | 5.06 | 65.1 | |
| 99 | 5.02 | 65.9 | |
| 100 | 4.99 | 66.8 | 50.1 |
| 101 | 4.96 | 67.4 | |
| 102 | 4.93 | 68.1 | |
| 103 | 4.90 | 68.9 | |
| 104 | 4.86 | 69.6 | |
| 105 | 4.83 | 70.3 | |
| 106 | 4.80 | 71.1 | |
| 107 | 4.77 | 71.8 | |
| 108 | 4.74 | 72.5 | |
| 109 | 4.70 | 73.3 | |
| 110 | 4.87 | 74.0 | 58.0 |
| 111 | 4.64 | 74.7 | |
| 112 | 4.61 | 75.4 | |
| 113 | 4.58 | 76.1 | |
| 114 | 4.54 | 76.8 | |
| 115 | 4.51 | 77.5 | |
| 116 | 4.48 | 78.2 | |
| 117 | 4.45 | 78.9 | |
| 118 | 4.42 | 79.6 | |
| 119 | 4.38 | 80.3 | |
| 120 | 4.35 | 81.0 | 65.4 |
| 121 | 4.32 | 81.7 | |
| 122 | 4.29 | 82.3 | |
| 123 | 4.26 | 83.0 | |
| 124 | 4.22 | 83.7 | |
| 125 | 4.19 | 84.3 | |
| 126 | 4.16 | 85.0 | |
| 127 | 4.13 | 85.6 | |
| 128 | 4.10 | 86.3 | |
| 129 | 4.06 | 86.9 | |
| 130 | 4.03 | 87.6 | 72.8 |
| 131 | 4.00 | 88.2 | |
| 132 | 3.97 | 88.8 | |
| 133 | 3.94 | 89.4 | |
| 134 | 3.90 | 90.0 | |
| 135 | 3.87 | 90.6 | |
| 136 | 3.84 | 91.2 | |
| 137 | 3.81 | 91.8 | |
| 138 | 3.78 | 92.4 | |
| 139 | 3.74 | 93.0 | |
| 140 | 3.71 | 93.6 | 80.0 |
| 141 | 3.68 | 94.1 | |
| 142 | 3.65 | 94.7 | |
| 143 | 3.62 | 95.3 | |
| 144 | 3.58 | 95.8 | |
| 145 | 3.55 | 96.4 | |
| 146 | 3.52 | 96.9 | |
| 147 | 3.49 | 97.4 | |
| 148 | 3.46 | 98.0 | |
| 149 | 3.42 | 98.5 | |
| 150 | 3.39 | 99.0 | 86.4 |
| 151 | 3.36 | 99.5 | |
| 152 | 3.33 | 100.0 | |
| 153 | 3.30 | 100.5 | |
| 154 | 3.26 | 101.0 | |
| 155 | 3.23 | 101.5 | |
| 156 | 3.20 | 102.0 | |
| 157 | 3.17 | 102.4 | |
| 158 | 3.14 | 102.9 | |
| 159 | 3.10 | 103.4 | |
| 160 | 3.07 | 103.8 | 93.0 |
| 161 | 3.04 | 104.2 | |
| 162 | 3.01 | 104.7 | |
| 163 | 2.98 | 105.1 | |
| 164 | 2.94 | 105.5 | |
| 165 | 2.91 | 106.0 | |
| 166 | 2.88 | 106.4 | |
| 167 | 2.85 | 106.8 | |
| 168 | 2.82 | 107.2 | |
| 169 | 2.78 | 107.6 | |
| 170 | 2.75 | 107.9 | 98.8 |
| 171 | 2.72 | 108.3 | |
| 172 | 2.69 | 108.7 | |
| 173 | 2.66 | 109.1 | |
| 174 | 2.62 | 109.4 | |
| 175 | 2.59 | 109.8 | |
| 176 | 2.56 | 110.1 | |
| 177 | 2.53 | 110.4 | |
| 178 | 2.50 | 110.8 | |
| 179 | 2.46 | 111.1 | |
| 180 | 2.43 | 111.4 | 104.2 |
| 181 | 2.40 | 111.7 | |
| 182 | 2.37 | 112.0 | |
| 183 | 2.34 | 112.3 | |
| 184 | 2.30 | 112.6 | |
| 185 | 2.27 | 112.9 | |
| 186 | 2.24 | 113.2 | |
| 187 | 2.21 | 113.4 | |
| 188 | 2.18 | 113.7 | |
| 189 | 2.14 | 113.9 | |
| 190 | 2.11 | 114.2 | 108.6 |
| 191 | 2.08 | 114.4 | |
| 192 | 2.05 | 114.7 | |
| 193 | 2.02 | 114.9 | |
| 194 | 1.98 | 115.1 | |
| 195 | 1.95 | 115.4 | |
| 196 | 1.92 | 115.6 | |
| 197 | 1.89 | 115.8 | |
| 198 | 1.86 | 116.0 | |
| 199 | 1.82 | 116.2 | |
| 200 | 1.79 | 116.4 | 112.6 |
| 201 | 1.76 | 116.5 | |
| 202 | 1.73 | 116.7 | |
| 203 | 1.70 | 116.9 | |
| 204 | 1.66 | 117.1 | |
| 205 | 1.63 | 117.2 | |
| 206 | 1.60 | 117.4 | |
| 207 | 1.57 | 117.5 | |
| 208 | 1.54 | 117.7 | |
| 209 | 1.50 | 117.8 | |
| 210 | 1.47 | 117.9 | 115.6 |
| 211 | 1.44 | 118.1 | |
| 212 | 1.41 | 118.2 | |
| 213 | 1.38 | 118.3 | |
| 214 | 1.34 | 118.4 | |
| 215 | 1.31 | 118.5 | |
| 216 | 1.28 | 118.6 | |
| 217 | 1.25 | 118.7 | |
| 218 | 1.22 | 118.8 | |
| 219 | 1.18 | 118.9 | |
| 220 | 1.15 | 119.0 | 117.8 |
| 221 | 1.12 | 119.1 | |
| 222 | 1.09 | 119.1 | |
| 223 | 1.06 | 119.2 | |
| 224 | 1.02 | 119.3 | |
| 225 | 9.92 | 119.4 | |
| 226 | 9.60 | 119.4 | |
| 227 | 9.28 | 119.5 | |
| 228 | 8.98 | 119.5 | |
| 229 | 8.64 | 119.5 | |
| 230 | 8.32 | 119.8 | 119.4 |
| 231 | 8.00 | 119.7 | |
| 232 | 7.68 | 119.7 | |
| 233 | 7.36 | 119.7 | |
| 234 | 7.04 | 119.8 | |
| 235 | 6.72 | 119.8 | |
| 236 | 6.40 | 119.8 | |
| 237 | 6.08 | 119.8 | |
| 238 | 5.76 | 119.9 | |
| 239 | 5.44 | 119.9 | |
| 240 | 5.12 | 119.9 | 120.4 |
| 241 | 4.80 | 119.9 | |
| 242 | 4.48 | 119.9 | |
| 243 | 4.16 | 120.0 | |
| 244 | 3.84 | 120.0 | |
| 245 | 3.52 | 120.0 | |
| 246 | 3.20 | 120.0 | |
| 247 | 2.88 | 120.0 | |
| 248 | 2.56 | 120.0 | |
| 249 | 2.24 | 120.0 | |
| 250 | 1.92 | 120.0 | 120.8 |
| 251 | 1.60 | 120.0 | |
| 252 | 1.28 | 120.0 | |
| 253 | 9.60 | 120.0 | |
| 254 | 6.40 | 120.0 | |
| 255 | 3.20 | 120.0 | |

This inherently results in channel intensities that do not subsequently dim too much and look weak when the real time peak is significantly lower than the current stored maximum reference.

The combination of these implemented pulse width modulator techniques coupled with an analog frequency splitting circuit configuration that never saturates or clips are the reasons the audio to optical transformation is smooth and pleasing to the human senses being acted upon in the exemplary embodiment.

### Exemplary “No Music” Modes

During periods of no music, the optical rhythm controller may direct the connected distributed light module channels one through five to respond in unique, creative ways. There are, in one example embodiment, four defined no music modes that are easily selected via a pair of two position optical rhythm controller dip switches. The firmware defaults to a “no music” selected mode after each or both of the input channels has had less than a 40 mV (peak to peak) level for 10 contiguous seconds. The “no music” moding makes commercial application of the product easy, as the connected colored lights are automatically operable after a specialized presentation has concluded or in the process of changing scenes (as in a Christmas play, school play, etc.). The fifth channel from each distributed light module can be fitted with white or clear incandescent light bulb loads. The table below is a summary of exemplary mode definitions:

No Music Mode Summary

| Mode # | Function Description |
|---|---|
| 1 | channel #5 (white) full on, channels 1-4 |
| | off. |
| 2 | channels 1-5 full on |
| 3 | channels 1-4 full on, channel 5 off |
| 4 | channels 1-5 individually sequence off-on- |
| | off with overlap; start dim, brighten |
| | gradually, achieve maximum brightness, |
| | dim gradually -- as adjacent channel begins |
| | its start at dimming, increase in intensity as |
| | previous channel number extinguishes |
| | 100%. |

In the absence of music, the selected default mode in one example embodiment continues its described behavior ad infinitum. Music mode of operation doesn't begin again until greater than 40 mV (peak-to-peak) is received by ≧2 microcontroller inputs for greater than four seconds. This makes operation in a potentially noisy commercial arena practical and not subject to nuisance mode changes.

Upon re-entering a “no music” mode in the illustrative embodiment, the current peak reference level is forgotten; overwritten with a null zero. This allows the establishment of a brand new peak history to occur upon re-entering the valid “music mode”. This forgetting or time to reset the peak 100% threshold value is optimized at 7-10 seconds (delay). This allows for end of current song—reentry into new song to enjoy the still valid current history threshold stored value. Another reason this 7-10 seconds works so well in the illustrative embodiment is because of the optical rhythm controller's very wide amplitude dynamic range. In one illustrative arrangement, low music amplitude for 7-10 seconds (i.e. ≦40 millivolts peak to peak) indicates practically that the last song has really finished. Let “song” AKA “public address” AKA “aux. audio sources” be equivalent in all discussions herein.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the scope of the appended claims.

We claim:

1. An audio to optical converter comprising:
audio processing circuitry coupled to receive at least one audio input, said audio processing circuitry including a detector that detects the absence of predetermined content within said audio input; and
an output circuit coupled to said audio processing circuitry, said output circuit having first and second modes, said first mode driving a visual display in response to said audio input, said second mode driving said visual display in response to detection of said absence of said predetermined content.

2. The converter of claim 1 wherein said visual display comprises multi-colored electrical lights.

3. The converter of claim 1 wherein said visual display comprises multiple light strings on a Christmas tree.

4. The converter of claim 1 wherein said second mode drives at least a part of said visual display to provide a positive visual indication in response to said absence detection.

5. The converter of claim 1 wherein said audio processing circuitry includes both analog and digital components.

6. The converter of claim 1 wherein said audio processing circuitry applies a dynamic release characteristic.

7. The converter of claim 6 wherein said dynamic release characteristic includes a fixed component and a dynamic component.

8. The converter of claim 1 wherein said audio processing circuitry includes a plurality of bandpass-limited channels.

9. The converter of claim 1 wherein said audio processing circuitry non-linearly converts audio input amplitude levels to output driving levels.

10. The converter of claim 1 wherein said audio processing circuitry and said output circuitry are disposed in separate and distinct housings spatially separated from one another.

11. The converter of claim 1 including multiple output circuits connected to said audio processing circuitry via a distribution network.

12. The converter of claim 1 further including a zero crossing detector that synchronizes said audio processing circuitry with AC mins zero crossing.

13. The converter of claim 1 wherein said audio processing circuitry includes a wide dynamic range to respond to a variety of different audio input levels.

14. The converter of claim 1 wherein said audio processing circuitry includes automatic dynamic input level thresholding.

15. The converter of claim 1 further including a cable that connects said audio processing circuitry to a remotely located output circuit.

16. The converter of claim 1 wherein said output circuit includes plural electrical output sockets for driving a corresponding plurality of multi-colored illuminating elements.

17. A holiday lighting control system for use with a Christmas tree light display having a plurality of differently-colored light strings, said system comprising:
an audio processing module adapted for coupling to an audio input;
an output module including a plurality of electrical output sockets for connection to said corresponding plurality of light strings, and
a control link that couples control signals between said audio processing module and said output module such that said audio processing module and said output module can be located remotely from one another,
wherein said audio processing module detects the absence of audio input for a predetermined time period and controls said output module to drive said light strings so that at least some of said light strings are illuminated when audio is absent for a predetermined period.

18. The system as in claim 17 wherein said audio processing module includes a soul decay characteristic that is dependent on both frequency and decay of the input signal.

19. The system as in claim 17 wherein said audio processing module includes a zero crossing detector.

20. The system of claim 17 wherein said audio processing module includes a micro controller.

21. The system of claim 17 wherein said audio processing module includes a plurality of independent, bandpass-limited audio processing channels corresponding to said plurality of said output sockets.

22. The system of claim 17 wherein said audio processing module is adapted for coupling to a plurality of output modules via an interconnection network.

23. The system of claim 17 wherein said audio processing module includes a dynamic level thresholding circuit.

24. A method of controlling a multi-colored holiday display comprising:
filtering an audio input signal into a plurality of band-limited audio channels;
applying a dynamic decay characteristic to each of said plurality of channels; and
generating a plurality of output driving currents for application to respective electrical illuminating sources, said plurality of output driving currents being responsive to respective corresponding bandpass-limited channels.

25. A method of providing a multi-colored lighting display comprising:
receiving an audio input from at least one audio source;
processing said audio input into a plurality of band-limited channels to derive a corresponding plurality of audio spectral content signals;
applying respective dynamic decay characteristics to each of said signals;
detecting, in response to said signals, whether content is absent from said audio input; and
driving respective corresponding colored illumination sources in response to said decay characteristic-modified signals when content is present, and driving said multi-colored illumination elements independently of said audio input when audio content is detected to be absent.
